(19) United States
(12) Patent Application Publication
(10) Pub. No.: US 2015/0271231 A1
(43) Pub. Date: Sep. 24, 2015

(54) TRANSPORT ACCELERATOR IMPLEMENTING ENHANCED SIGNALING

(71) Applicant: QUALCOMM Incorporated, San Diego, CA (US)

(72) Inventors: Michael George Luby, Berkeley, CA (US); Fatih Ulupinar, San Diego, CA (US); Lorenz Christoph Minder, Evanston, IL (US); Deviprasad Putchala, San Diego, CA (US); Yinian Mao, San Diego, CA (US); Thomas Stockhammer, Bergen (DE)

(73) Assignee: QUALCOMM Incorporated, San Diego, CA (US)

(21) Appl. No.: 14/289,348

(22) Filed: May 28, 2014

Related U.S. Application Data
(60) Provisional application No. 61/954,955, filed on Mar. 18, 2014.

(51) Int. Cl. H04L 29/06; H04L 29/08

(52) U.S. Cl. CPC H04L 65/60; H04L 67/02; H04L 65/4084

(57) ABSTRACT

Transport accelerator (TA) systems and methods for accelerating delivery of content to a user agent (UA) of a client device are provided according to embodiments of the present disclosure. Embodiments comprise a TA architecture implementing a connection manager (CM) and a request manager (RM). A RM of embodiments subdivides a fragment request provided by the UA into a plurality of chunk requests for requesting chunks of the content. A CM of embodiments signals to the RM, that the CM is ready for an additional chunk request of the content. Priority information is provided according to embodiments, such as by the UA, wherein the priority information indicates a priority of a corresponding fragment request relative to other fragment requests.

### PRIORITY AND RELATED APPLICATIONS STATEMENT

The present application claims priority to co-pending U.S. Provisional Patent Application No. 61/954,955, entitled “TRANSPORT ACCELERATOR IMPLEMENTING ENHANCED SIGNALING,” filed Mar. 18, 2014, the disclosure of which is hereby incorporated herein by reference. This application is related to commonly assigned United States patent applications serial number [Attorney Docket Number QLXX.P0446US (133355U1)] entitled “TRANSPORT ACCELERATOR IMPLEMENTING EXTENDED TRANSMISSION CONTROL FUNCTIONALITY,” serial number [Docket Number QLXX.P0446US.B (133355U2)] entitled “TRANSPORT ACCELERATOR IMPLEMENTING EXTENDED TRANSMISSION CONTROL FUNCTIONALITY,” serial number [Attorney Docket Number QLXX.P0448US (140059)] entitled “TRANSPORT ACCELERATOR IMPLEMENTING REQUEST MANAGER AND CONNECTION MANAGER FUNCTIONALITY,” serial number [Attorney Docket Number QLXX.P0449US (140060)] entitled “TRANSPORT ACCELERATOR IMPLEMENTING SELECTIVE UTILIZATION OF REDUNDANT ENCODED CONTENT DATA FUNCTIONALITY,” serial number [Attorney Docket Number QLXX.P0450US (140061)] entitled “TRANSPORT ACCELERATOR IMPLEMENTING A MULTIPLE INTERFACE ARCHITECTURE,” and serial number [Attorney Docket Number QLXX.P0451US (140062)] entitled “TRANSPORT ACCELERATOR IMPLEMENTING CLIENT SIDE TRANSMISSION FUNCTIONALITY,” each of which being concurrently filed herewith and the disclosures of which are expressly incorporated by reference herein in their entirety.

### DESCRIPTION OF THE RELATED ART

More and more content is being transferred over available communication networks. Often, this content includes numerous types of data including, for example, audio data, video data, image data, etc. Video content, particularly high resolution video content, often comprises a relatively large data file or other collection of data. Accordingly, a user agent (UA) on an end user device or other client device which is consuming such content often requests and receives a sequence of fragments of content comprising the desired video content. For example, a UA may comprise a client application or process executing on a user device that requests data, often multimedia data, and receives the requested data for further processing and possibly for display on the user device.

Many types of applications today rely on HTTP for the foregoing content delivery. In many such applications the performance of the HTTP transport is critical to the user's experience with the application. For example, live streaming has several constraints that can hinder the performance of a video streaming client. Two constraints stand out particularly. First, media segments become available one after another over time. This constraint prevents the client from continuously downloading a large portion of data, which in turn affects the accuracy of download rate estimate. Since most streaming clients operate on a “request-download-estimate”, loop, it generally does not do well when the download estimate is inaccurate. Second, when viewing a live event streaming, users generally don't want to suffer a long delay from the actual live event timeline. Such a behavior prevents the streaming client from building up a large buffer, which in turn may cause more rebuffering.

If the streaming client operates over Transmission Control Protocol (TCP) (e.g., as do most Dynamic Adaptive Streaming over HTTP (DASH) clients), the application at the top of the TCP stack is provided only with the data in response to the requests. Accordingly, other than maintaining a receive window for referencing in determining when to make a request for data, the streaming client and/or applications thereof are provided little from which to optimize transfer of the desired streaming data. For example, in typical DASH client operation the fragment requests may be made such that they become stale (e.g., a bitrate selected when the request is made is no longer appropriate when the data is finally transferred), cause or contribute to network congestion (e.g., data requests continue to be made despite transfer of data being delayed in the network), etc. However, due to a relatively large deployment of media servers operable in accordance with the TCP standard, it is problematic and generally not widely acceptable to require changes to such servers, even where such changes may provide for optimized transmission performance. Accordingly, the widespread adoption and utilization of TCP for transmission of streaming data remains the standard for a significant amount of the streaming content implementations.

### SUMMARY

A method for accelerating, by a transport accelerator (TA), delivery of content to a user agent (UA) of a client device is provided according to embodiments of the present disclosure. The method according to embodiments includes subdividing, by a request manager (RM) of the TA, a fragment request provided by the UA into a plurality of chunk requests for requesting chunks of the content, and signaling, by a connection manager (CM) of the TA to the RM, that the CM is ready for an additional chunk request of the content.

An apparatus for accelerating, by a transport accelerator (TA), delivery of content to a user agent (UA) of a client device is provided according to embodiments of the present disclosure. The apparatus according to embodiments includes means for subdividing, by a request manager (RM) of the TA, a fragment request provided by the UA into a plurality of chunk requests for requesting chunks of the content, and means for signaling, by a connection manager (CM) of the TA to the RM, that the CM is ready for an additional chunk request of the content.

A computer program product for accelerating, by a transport accelerator (TA), delivery of content to a user agent (UA) of a client device is provided according to embodiments of the present disclosure. The computer program product according to embodiments includes a non-transitory computer-readable medium having program code recorded thereon. The program code of embodiments includes program code to subdivide, by a request manager (RM) of the TA, a fragment request provided by the UA into a plurality of chunk requests for requesting chunks of the content, and program code to signal, by a connection manager (CM) of the TA to the RM, that the CM is ready for an additional chunk request of the content.

An apparatus for accelerating, by a transport accelerator (TA), delivery of content to a user agent (UA) of a client device is provided according to embodiments of the present disclosure. The apparatus of embodiments includes at least one processor, and a memory coupled to the at least one processor. The at least one processor is configured according to embodiments to subdivide, by a request manager (RM) of the TA, a fragment request provided by the UA into a plurality of chunk requests for requesting chunks of the content, and to signal, by a connection manager (CM) of the TA to the RM, that the CM is ready for an additional chunk request of the content.

Further embodiments of the present disclosure provide a method for accelerating, by a transport accelerator (TA), delivery of content to a user agent (UA) of a client device. The method of embodiments includes receiving, by a request manager (RM) of the TA from the UA, fragment requests for requesting chunks of the content, wherein priority information is provided by the UA in association with the fragment requests, wherein the priority information indicates a priority of a corresponding fragment request relative to other fragment requests. The method of embodiments further includes subdividing, by the RM, the fragment requests each into a plurality of chunk requests, and providing, by the RM to a connection manager (CM) of the TA, chunk requests of the plurality of chunk requests in accordance with a priority of the fragment requests from which the chunk requests were subdivided.

Embodiments of the present disclosure provide an apparatus for accelerating, by a transport accelerator (TA), delivery of content to a user agent (UA) of a client device. The apparatus of embodiments includes means for receiving, by a request manager (RM) of the TA from the UA, fragment requests for requesting chunks of the content, wherein priority information is provided by the UA in association with the fragment requests, wherein the priority information indicates a priority of a corresponding fragment request relative to other fragment requests. The apparatus of embodiments further includes means for subdividing, by the RM, the fragment requests each into a plurality of chunk requests, and means for providing, by the RM to a connection manager (CM) of the TA, chunk requests of the plurality of chunk requests in accordance with a priority of the fragment requests from which the chunk requests were subdivided.

Embodiments of the present disclosure provide a computer program product for accelerating, by a transport accelerator (TA), delivery of content to a user agent (UA) of a client device. The computer program product includes a non-transitory computer-readable medium having program code recorded thereon. The program code of embodiments includes program code to receive, by a request manager (RM) of the TA from the UA, fragment requests for requesting chunks of the content, wherein priority information is provided by the UA in association with the fragment requests, wherein the priority information indicates a priority of a corresponding fragment request relative to other fragment requests. The program code of embodiments further includes program code to subdivide, by the RM, the fragment requests each into a plurality of chunk requests, and program code to provide, by the RM to a connection manager (CM) of the TA, chunk requests of the plurality of chunk requests in accordance with a priority of the fragment requests from which the chunk requests were subdivided.

Embodiments of the present disclosure provide an apparatus for accelerating, by a transport accelerator (TA), delivery of content to a user agent (UA) of a client device. The apparatus includes at least one processor, and a memory coupled to the at least one processor. The at least one processor of embodiments is configured to receive, by a request manager (RM) of the TA from the UA, fragment requests for requesting chunks of the content, wherein priority information is provided by the UA in association with the fragment requests, wherein the priority information indicates a priority of a corresponding fragment request relative to other fragment requests. The at least one processor of embodiments is further configured to subdivide, by the RM, the fragment requests each into a plurality of chunk requests, and to provide, by the RM to a connection manager (CM) of the TA, chunk requests of the plurality of chunk requests in accordance with a priority of the fragment requests from which the chunk requests were subdivided.

### BRIEF DESCRIPTION OF THE DRAWINGS

FIG. 1A shows a system adapted for transport acceleration operation according to embodiments of the present disclosure.

FIG. 1B shows detail with respect to embodiments of a Request Manager and Connection Manager as may be implemented with respect to configurations of a Transport Accelerator according to embodiments of the present disclosure.

FIG. 2 shows a flow diagram illustrating operation of a Transport Accelerator to provide enhanced signaling in the form of readiness signaling according to embodiments of the present disclosure.

FIG. 3 shows an exemplary scenario where a Connection Manager is not currently able to immediately make a chunk request.

FIG. 4 shows an exemplary scenario where a Connection Manager is currently able to immediately make a chunk request.

FIG. 5 shows an application programming interface as may be implemented between a Request Manager and a Connection Manager of embodiments of the present disclosure.

FIG. 6 shows an exemplary scenario where a Request Manager may be determined not to be ready for another fragment request according to embodiments of the present disclosure.

FIG. 7 shows an exemplary scenario where a Request Manager may be determined not to have received fragment requests from User Agent for which the Request Manager can make a chunk request.

FIG. 8 shows an application programming interface as may be implemented between a Request Manager and a User Agent of embodiments of the present disclosure.

FIGS. 9A-9C show exemplary scenarios where a User Agent comprises an on-demand adaptive HTTP streaming client and the timing with respect to readiness signaling and fragment requests according to embodiments of the present disclosure.

FIG. 9D shows an exemplary scenario where a User Agent comprises a browser and the timing with respect to readiness signaling and fragment requests according to embodiments of the present disclosure.

FIG. 10 shows a Transport Accelerator proxy configuration according to embodiments of the present disclosure.

FIG. 11 shows a flow diagram illustrating operation of a Transport Accelerator implementing enhanced signaling in the form of priority signaling according to embodiments of the present disclosure.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the term “content” may include data having video, audio, combinations of video and audio, or other data at one or more quality levels, the quality level determined by bit rate, resolution, or other factors. The content may also include executable content, such as: object code, scripts, byte code, markup language files, and patches. In addition, “content” may also include files that are not executable in nature, such as documents that may need to be opened or other data files that need to be accessed.

As used in this description, the term “fragment” refers to one or more portions of content that may be requested by and/or received at a user device.

As used in this description, the term “streaming content” refers to content that may be sent from a server device and received at a user device according to one or more standards that enable the real-time transfer of content or transfer of content over a period of time. Examples of streaming content standards include those that support de-interleaved (or multiple) channels and those that do not support de-interleaved (or multiple) channels.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

As used herein, the terms “user equipment,” “user device,” and “client device” include devices capable of requesting and receiving content from a web server and transmitting information to a web server. Such devices can be a stationary devices or mobile devices. The terms “user equipment,” “user device,” and “client device” can be used interchangeably.

As used herein, the term “user” refers to an individual receiving content on a user device or on a client device and transmitting information to a website.

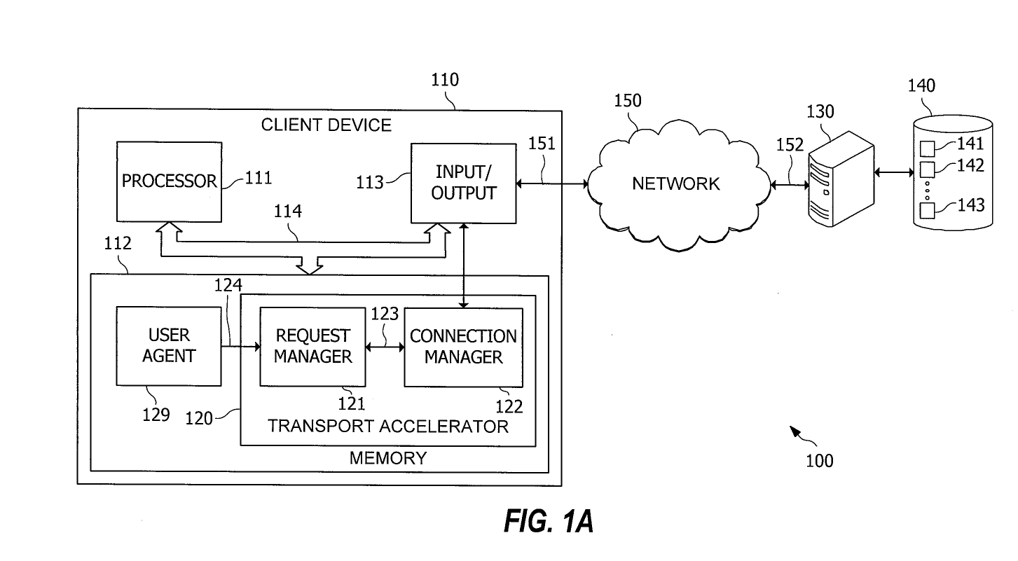

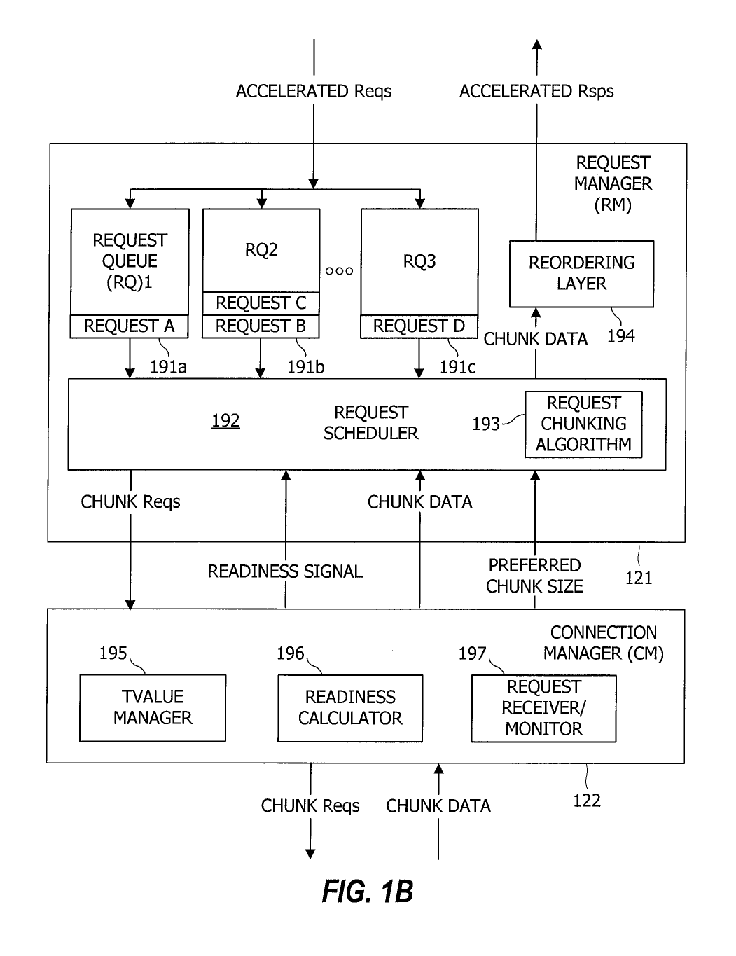

FIG. 1 shows system 100 adapted according to the concepts herein to provide transfer of content, such as may comprise audio data, video data, image data, file data, etc., over communication networks. Accordingly, client device 110 is shown in communication with server 130 via network 150, whereby server 130 may transfer various content stored in database 140 to client device 110 in accordance with the concepts of the present disclosure. It should be appreciated that, although only a single client device and a single server and database are represented in FIG. 1, system 100 may comprise a plurality of any or all such devices. For example, server 130 may comprise a server of a server farm, wherein a plurality of servers may be disposed centrally and/or in a distributed configuration, to serve high levels of demand for content transfer. Alternatively, server 130 may be collocated on the same device as transport accelerator 120 (e.g., connected to transport accelerator 120 directly through I/O element 113, instead of through network 150) such as when some or all of the content resides in a database 140 (cache) that is also collocated on the device and provided to transport accelerator 120 through server 130. Likewise, users may possess a plurality of client devices and/or a plurality of users may each possess one or more client devices, any or all of which are adapted for content transfer according to the concepts herein.

Client device 110 may comprise various configurations of devices operable to receive transfer of content via network 150. For example, client device 110 may comprise a wired device, a wireless device, a personal computing device, a tablet or pad computing device, a portable cellular telephone, a WiFi enabled device, a Bluetooth enabled device, a television, a pair of glasses having a display, a pair of augmented reality glasses, or any other communication, computing or interface device connected to network 150 which can communicate with server 130 using any available methodology or infrastructure. Client device 110 is referred to as a “client device” because it can function as, or be connected to, a device that functions as a client of server 130.

Client device 110 of the illustrated embodiment comprises a plurality of functional blocks, shown here as including processor 111, memory 112, and input/output (I/O) element 113. Although not shown in the representation in FIG. 1 for simplicity, client device 110 may comprise additional functional blocks, such as a user interface, a radio frequency (RF) module, a camera, a sensor array, a display, a video player, a browser, etc., some or all of which may be utilized by operation in accordance with the concepts herein. The foregoing functional blocks may be operatively connected over one or more buses, such as bus 114. Bus 114 may comprises the logical and physical connections to allow the connected elements, modules, and components to communicate and interoperate.

Memory 112 can be any type of volatile or non-volatile memory, and in an embodiment, can include flash memory. Memory 112 can be permanently installed in client device 110, or can be a removable memory element, such as a removable memory card. Although shown as a single element, memory 112 may comprise multiple discrete memories and/or memory types.

Memory 112 may store or otherwise include various computer readable code segments, such as may form applications, operating systems, files, electronic documents, content, etc. For example, memory 112 of the illustrated embodiment comprises computer readable code segments defining Transport Accelerator (TA) 120 and UA 129, which when executed by a processor (e.g., processor 111) provide logic circuits operable as described herein. The code segments stored by memory 112 may provide applications in addition to the aforementioned TA 120 and UA 129. For example, memory 112 may store applications such as a browser, useful in accessing content from server 130 according to embodiments herein. Such a browser can be a web browser, such as a hypertext transfer protocol (HTTP) web browser for accessing and viewing web content and for communicating via HTTP with server 130 over connections 151 and 152, via network 150, if server 130 is a web server. As an example, an HTTP request can be sent from the browser in client device 110, over connections 151 and 152, via network 150, to server 130. A HTTP response can be sent from server 130, over connections 152 and 151, via network 150, to the browser in client device 110.

UA 129 is operable to request and/or receive content from a server, such as server 130. UA 129 may, for example, comprise a client application or process, such as a browser, a DASH client, a HTTP Live Streaming (HLS) client, etc., that requests data, such as multimedia data, and receives the requested data for further processing and possibly for display on a display of client device 110. For example, client device 110 may execute code comprising UA 129 for playing back media, such as a standalone media playback application or a browser-based media player configured to run in an Internet browser. In operation according to embodiments, UA 129 decides which fragments or sequences of fragments of a content file to request for transfer at various points in time during a streaming content session. For example, a DASH client configuration of UA 129 may operate to decide which fragment to request from which representation of the content (e.g., high resolution representation, medium resolution representation, low resolution representation, etc.) at each point in time, such as based on recent download conditions. Likewise, a web browser configuration of UA 129 may operate to make requests for web pages, or portions thereof, etc. Typically, the UA requests such fragments using HTTP requests.

TA 120 is adapted according to the concepts herein to provide enhanced delivery of fragments or sequences of fragments of desired content (e.g., the aforementioned content fragments as may be used in providing video streaming, file download, web-based applications, general web pages, etc.). TA 120 of embodiments is adapted to allow a generic or legacy UA (i.e., a UA which has not been predesigned to interact with the TA) that only supports a standard interface, such as a HTTP 1.1 interface implementing standardized TCP transmission protocols, for making fragment requests to nevertheless benefit from using the TA executing those requests. Additionally or alternatively, TA 120 of embodiments provides an enhanced interface to facilitate providing further benefits to UAs that are designed to take advantage of the functionality of the enhanced interface. TA 120 of embodiments is adapted to execute fragment requests in accordance with existing content transfer protocols, such as using TCP over a HTTP interface implementing standardized TCP transmission protocols, thereby allowing a generic or legacy media server (i.e., a media server which has not been predesigned to interact with the TA) to serve the requests while providing enhanced delivery of fragments to the UA and client device.

In providing the foregoing enhanced fragment delivery functionality, TA 120 of the embodiments herein comprises architectural components and protocols as described herein. For example, TA 120 of the embodiment illustrated in FIG. 1 comprises Request Manager (RM) 121 and Connection Manager (CM) 122 which cooperate to provide various enhanced fragment delivery functionality, as described further below.

In addition to the aforementioned code segments forming applications, operating systems, files, electronic documents, content, etc., memory 112 may include or otherwise provide various registers, buffers, and storage cells used by functional block so client device 110. For example, memory 112 may comprise a play-out buffer, such as may provide a first-in/first-out (FIFO) memory for spooling data of fragments for streaming from server 130 and playback by client device 110.

Processor 111 of embodiments can be any general purpose or special purpose processor capable of executing instructions to control the operation and functionality of client device 110. Although shown as a single element, processor 111 may comprise multiple processors, or a distributed processing architecture.

I/O element 113 can include and/or be coupled to various input/output components. For example, I/O element 113 may include and/or be coupled to a display, a speaker, a microphone, a keypad, a pointing device, a touch-sensitive screen, user interface control elements, and any other devices or systems that allow a user to provide input commands and receive outputs from client device 110. Any or all such components may be utilized to provide a user interface of client device 110. Additionally or alternatively, I/O element 113 may include and/or be coupled to a disk controller, a network interface card (NIC), a radio frequency (RF) transceiver, and any other devices or systems that facilitate input and/or output functionality of client device 110.

In operation to access and play streaming content, client device 110 communicates with server 130 via network 150, using links 151 and 152, to obtain content data (e.g., as the aforementioned fragments) which, when rendered, provide playback of the content. Accordingly, UA 129 may comprise a content player application executed by processor 111 to establish a content playback environment in client device 110. When initiating playback of a particular content file, UA 129 may communicate with a content delivery platform of server 130 to obtain a content identifier (e.g., one or more lists, manifests, configuration files, or other identifiers that identify media segments or fragments, and their timing boundaries, of the desired content). The information regarding the media segments and their timing is used by streaming content logic of UA 129 to control requesting fragments for playback of the content.

Server 130 comprises one or more systems operable to serve desired content to client devices. For example, server 130 may comprise a standard HTTP web server operable to stream content to various client devices via network 150. Server 130 may include a content delivery platform comprising any system or methodology that can deliver content to user device 110. The content may be stored in one or more database in communication with server 130, such as database 140 of the illustrated embodiment. Database 140 may be stored on server 130 or may be stored on one or more servers communicatively coupled to server 130. Content of database 140 may comprise various forms of data, such as video, audio, streaming text, and any other content that can be transferred to client device 110 over a period of time by server 130, such as live webcast content and stored media content.

Database 140 may comprise a plurality of different source or content files and/or a plurality of different representations of any particular content (e.g., high resolution representation, medium resolution representation, low resolution representation, etc.). For example, content file 141 may comprise a high resolution representation, and thus high bit rate representation when transferred, of a particular multimedia compilation while content file 142 may comprise a low resolution representation, and thus low bit rate representation when transferred, of that same particular multimedia compilation. Additionally or alternatively, the different representations of any particular content may comprise a Forward Error Correction (FEC) representation (e.g., a representation including redundant encoding of content data), such as may be provided by content file 143. A Uniform Resource Locator (URL), Uniform Resource Identifier (URI), and/or Uniform Resource Name (URN) is associated with all of these content files according to embodiments herein, and thus such URLs, URIs, and/or URNs may be utilized, perhaps with other information such as byte ranges, for identifying and accessing requested data.

Network 150 can be a wireless network, a wired network, a wide area network (WAN), a local area network (LAN), or any other network suitable for the transfer of content as described herein. In an embodiment, network 150 can comprise at least portions of the Internet. Client device 110 can be connected to network 150 over a bi-directional connection, such as is represented by network connection 151. Alternatively, client device 110 can be connected via a uni-directional connection, such as that provided by a Multimedia Broadcast Multimedia System (MBMS) enabled network (e.g., connections 151, 152 and network 150 may comprise a MBMS network, and server 130 may comprise a Broadcast Multicast Service Center (BM-SC) server). The connection can be a wired connection or can be a wireless connection. In an embodiment, connection 151 can be a wireless connection, such as a cellular 4G connection, a wireless fidelity (WiFi) connection, a Bluetooth connection, or another wireless connection. Server 130 can be connected to network 150 over a bi-directional connection, such as represented by network connection 152. Server 130 can be connected to network 150 over a uni-directional connection (e.g. a MBMS network using protocols and services as described in 3GPP TS.26.346 or an ATSC 3.0 network). The connection can be a wired connection or can be a wireless connection.

Client device 110 of the embodiment illustrated in FIG. 1 comprises TA 120 operable to provide enhanced delivery of fragments or sequences of fragments of desired content according to the concepts herein. As discussed above, TA 120 of the illustrated embodiment comprises RM 121 and CM 122 which cooperate to provide various enhanced fragment delivery functionality. Interface 124 between UA 129 and RM 121 and interface 123 between RM 121 and CM 122 of embodiments provide an HTTP-like connection. For example, the foregoing interfaces may employ standard HTTP protocols as well as including additional signaling (e.g., provided using signaling techniques similar to those of HTTP) to support certain functional aspects of enhanced fragment delivery according to embodiments herein.

In operation according to embodiments RM 121 receives requests for fragments from UA 129 and decides what data to request from CM 122 to reliably receive and recover requested fragments. In accordance with embodiments herein, RM 121 is adapted to receive and respond to fragment requests from a generic or legacy UA (i.e., a UA which has not been predesigned to interact with the RM), thereby providing compatibility with such legacy UAs. Accordingly, RM 121 may operate to isolate UA 129 from the extended transmission protocol operation of TA 120. However, as will be more fully understood from the discussion which follows, UA 129 may be adapted for extended transmission protocol operation, whereby RM 121 and UA 129 cooperate to implement one or more features of the extended transmission protocol operation, such as through the use of signaling between RM 121 and UA 129 for implementing such features.

The size of data requests (referred to herein as “chunk requests” wherein the requested data comprises a “chunk”) made by RM 121 to CM 122 of embodiments can be much less than the size of the fragment requested by UA 129, and which fragment RM 121 is recovering. Thus, each fragment request from UA 129 may trigger RM 121 to generate and make multiple chunk requests to CM 122 to recover that fragment.

Some of the chunk requests made by RM 121 to CM 122 may be for data already requested that has not yet arrived, and which RM 121 has deemed may never arrive or may arrive too late. Additionally or alternatively, some of the chunk requests made by RM 121 to CM 122 may be for FEC encoded data generated from the original fragment, whereby RM 121 may FEC decode the data received from CM 122 to recover the fragment, or some portion thereof. RM 121 delivers recovered fragments to UA 129. Accordingly, there may be various configurations of RMs according to embodiments, such as may comprise a basic RM configuration (RM-basic) which does not use FEC data and thus only requests portions of data from the original source fragments and a FEC RM configuration (RM-FEC) which can request portions of data from the original source fragments as well as matching FEC fragments generated from the source fragments.

RM 121 of embodiments may be unaware of timing and/or bandwidth availability constraints, thereby facilitating a relatively simple interface between RM 121 and CM 122, and thus RM 121 may operate to make chunk requests without consideration of such constraints by RM 121. Alternatively, RM 121 may be adapted for awareness of timing and/or bandwidth availability constraints, such as may be supplied to RM 121 by CM 122 or other modules within client device 110, and thus RM 121 may operate to make chunk requests based upon such constraints.

RM 121 of embodiments is adapted for operation with a plurality of different CM configurations. Moreover, RM 121 of some embodiments may interface concurrently with more than one CM, such as to request data chunks of the same fragment or sequence of fragments from a plurality of CMs. Each such CM may, for example, support a different network interface (e.g., a first CM may have a local interface to an on-device cache, a second CM may use HTTP/TCP connections to a 3G network interface, a third CM may use HTTP/TCP connections to a 4G/LTE network interface, a fourth CM may use HTTP/TCP connections to a WiFi network interface, etc.).

In operation according to embodiments CM 122 interfaces with RM 121 to receive chunk requests, and sends those requests over network 150. CM 122 receives the responses to the chunk requests and passes the responses back to RM 121, wherein the fragments requested by UA 129 are resolved from the received chunks. Functionality of CM 122 operates to decide when to request data of the chunk requests made by RM 121. In accordance with embodiments herein, CM 122 is adapted to request and receive chunks from generic or legacy servers (i.e., a server which has not been predesigned to interact with the TA). For example, the server(s) from which CM 122 requests the data may comprise standard HTTP web servers. Alternatively, the server(s) from which CM 122 receives the data may comprise BM-SC servers used in MBMS services deployment.

As with RM 121 discussed above, there may be various configurations of CMs according to embodiments. For example, a multiple connection CM configuration (e.g., CM-mHTTP) may be provided whereby the CM is adapted to use HTTP over multiple TCP connections. A multiple connection CM configuration may operate to dynamically vary the number of connections (e.g., TCP connections), such as depending upon network conditions, demand for data, congestion window, etc. As another example, an extended transmission protocol CM configuration (e.g., CM-xTCP) may be provided wherein the CM uses HTTP on top of an extended form of a TCP connection (referred to herein as xTCP). Such an extended transmission protocol may provide operation adapted to facilitate enhanced delivery of fragments by TA 120 according to the concepts herein. For example, an embodiment of xTCP provides acknowledgments back to the server even when sent packets are lost (in contrast to the duplicate acknowledgement scheme of TCP when packets are lost). Such a xTCP data packet acknowledgment scheme may be utilized by TA 120 to avoid the server reducing the rate at which data packets are transmitted in response to determining that data packets are missing. As still another example, a proprietary protocol CM configuration (e.g., CM-rUDP) wherein the CM uses a proprietary User Datagram Protocol (UDP) protocol and the rate of sending response data from a server may be at a constant preconfigured rate, or there may be rate management within the protocol to ensure that the send rate is as high as possible without undesirably congesting the network. Such a proprietary protocol CM may operate in cooperation with proprietary servers that support the proprietary protocol.

FIG. 1B shows detail with respect to embodiments of RM 121 and CM 122 as may be implemented with respect to configurations of TA 120 as illustrated in FIG. 1A. In particular, RM 121 is shown as including request queues (RQs) 191a-191c, request scheduler 192 (including request chunking algorithm 193), and reordering layer 194. CM 122 is shown as including Tvalue manager 195, readiness calculator 196, and request receiver/monitor 197. It should be appreciated that, although particular functional blocks are shown with respect to the embodiments of RM 121 and CM 122 illustrated in FIG. 1B, additional or alternative functional blocks may be implemented for performing functionality according to embodiments as described herein.

RQs 191a-191c are provided in the embodiment of RM 121 illustrated in FIG. 1B to provide queuing of requests received by TA 120, which are provided by one or more UA (e.g., UA 129). The different RQs of the plurality of RQs shown in the illustrated embodiment may be utilized for providing queuing with respect to various requests. For example, different ones of the RQs may each be associated with different levels of request priority (e.g., live streaming media requests may receive highest priority, while on-demand streaming media receives lower priority, and web page content receives still lower priority). Similarly, different ones of the RQs may each be associated with different UAs, different types of UAs, etc. It should be appreciated that, although three such queues are represented in the illustrated embodiment, embodiments herein may comprise any number of such RQs.

Request scheduler 192 of embodiments implements one or more scheduling algorithms for scheduling fragment requests and/or chunk requests in accordance with the concepts herein. For example, logic of request scheduler 192 may operate to determine whether the RM is ready for a fragment request from a UA based upon when the amount of data received or requested but not yet received for a fragment currently being requested by the RM falls below some threshold amount, when the RM has no already received fragment requests for which the RM can make another chunk request, etc. Additionally or alternatively, logic of request scheduler 192 may operate to determine whether a chunk request is to be made to provide an aggregate download rate of the connections which is approximately the maximum download rate possible given current network conditions, to result in the amount of data buffered in the network is as small as possible, etc. Request scheduler 192 may, for example, operate to query the CM for chunk request readiness, such whenever the RM receives a new data download request from the UA, whenever the RM successfully issues a chunk request to the CM to check for continued readiness to issue more requests for the same or different origin servers, whenever data download is completed for an already issued chunk request, etc.

Request scheduler 192 of the illustrated embodiment is shown to include fragment request chunking functionality in the form of request chunking algorithm 193. Request chunking algorithm 193 of embodiments provides logic utilized to subdivide requested fragments to provide a plurality of corresponding smaller data requests. The above referenced patent application entitled “TRANSPORT ACCELERATOR IMPLEMENTING REQUEST MANAGER AND CONNECTION MANAGER FUNCTIONALITY” provides additional detail with respect to computing an appropriate chunk size according to embodiments as may be implemented by request chunking algorithm 193.

Reordering layer 194 of embodiments provides logic for reconstructing the requested fragments from the chunks provided in response to the aforementioned chunk requests. It should be appreciated that the chunks of data provided in response to the chunk requests may be received by TA 120 out of order, and thus logic of reordering layer 194 may operate to reorder the data, perhaps making requests for missing data, to thereby provide requested data fragments for providing to the requesting UA(s).

Tvalue manager 195 of the illustrated embodiment of CM 122 provides logic for determining and/or managing one or more parameters (e.g., threshold parameter, etc.) for providing control with respect to chunk requests (e.g., determining when a chunk request is to be made). Similarly, readiness calculator 196 of the illustrated embodiment of CM 122 provides logic for determining and/or managing one or more parameters (e.g., download rate parameters) for providing control with respect to chunk requests (e.g., signaling readiness for a next chunk request between CM 122 and RM 121). Detail with respect to the calculation of such parameters and their use according to embodiments is provided in the above reference patent application entitled “TRANSPORT ACCELERATOR IMPLEMENTING REQUEST MANAGER AND CONNECTION MANAGER FUNCTIONALITY”.

Request receiver/monitor 197 of embodiments provides logic operable to manage chunk requests. For example, request receiver/monitor 197 may operate to receive chunk requests from RM 121, to monitor the status of chunk requests made to one or more content servers, and to receive data chunks provided in response to the chunk requests.

It should be appreciated that, although the illustrated embodiment has been discussed with respect to CM 122 requesting data from a source file from server 130, the source files may be available on servers or may be stored locally on the client device, depending on the type of interface the CM has to access the data. In some embodiments, FEC files that contain repair symbols generated using FEC encoding from the matching source files may also be available on the servers. In such embodiments there may, for example, be one FEC file for each source file, wherein each FEC file is generated from the source file using FEC encoding techniques known in the art independent of the particular embodiment of CM used to request the data.

Further, in accordance with embodiments, client device 110 may be able to connect to one or more other devices (e.g., various configurations of devices disposed nearby), referred to herein as helper devices (e.g., over a WiFi or Bluetooth interface), wherein such helper devices may have connectivity to one or more servers, such as server 130, through a 3G or LTE connection, potentially through different carriers for the different helper devices. Thus, client device 110 may be able to use the connectivity of the helper devices to send chunk requests to one or more servers, such as server 130. In this case, there may be a CM within TA 120 to connect to and send chunk requests and receive responses to each of the helper devices. In such an embodiment, the helper devices may send different chunk request for the same fragment to the same or different servers (e.g., the same fragment may be available to the helper devices on multiple servers, where for example the different servers are provided by the same of different content delivery network providers).

In operation according to embodiments, UA 129 ultimately determines when to make a next fragment request and what fragment to request (e.g., as may be indicated by a URL it provides to RM 121). The particular fragment UA 129 requests next may depend on the timing of when the request is made, such as where the request is made in response to one or more of a user's actions, network conditions, and/or other factors. For example, where UA 129 is downloading and playing back video content for an end user on the device display, when the user decides to start watching content UA 129 may operate to determine the first fragment to request (e.g., possibly among many different representations, such as different bitrate representations, of the content) for that content starting from a presentation time specified by the user. When the user decides to stop watching one content and watch another, or does a seek within the same content (e.g., backwards or forwards in presentation time), UA 129 of embodiments operates to stop the old content and start the new as fast as possible, whereby the next fragment request will be for the new content from the specified starting presentation time specified by the user chosen from a representation that is appropriate for current network conditions. When the user decides to stop watching content, or pause play back of content, UA 129 may stop or pause the content, such as by stopping requesting fragments or, for a playback pause, possibly stopping requesting fragments once the client device media buffer is full.

Where UA 129 comprises an adaptive streaming client, such as a DASH client, the UA may operate to determine at which quality to play back the content at any particular point in time, such as depending on network conditions and/or other factors (e.g., size of the display, the remaining battery life, etc.). For example, if the download rate is currently 2 Mbps per second, then the next request from UA 129 to RM 121 for a video fragment might be for a video fragment encoded at 1.5 Mbps, whereas if the download rate is measured instead at 1 Mbps then the next request might be for a video fragment encoded at 750 Kbps.

When UA 129 determines that it is appropriate to request a fragment, the UA may provide the corresponding fragment request to RM 121 at any point in time. However, it may be advantageous for the UA to make the next fragment request as late as possible, without slowing down the delivery of fragments from the RM, whereby the UA can wait to make the decision about the next fragment request.

For example, where UA 129 comprises an adaptive streaming client, there may be many possible representations of a next fragment to request (e.g., each possibility may correspond to a representation of the content at a different quality playback, such as a 250 Kbps, a 500 Kbps, and a 1 Mbps representation of the content, and each video fragment comprises the media data for 5 seconds of video playback). Thus, there may be a plurality of different possible fragments of differing sizes that the streaming client could choose to request to obtain the media data for the next portion of video playback. UA 129 may incorporate logic that selects the next fragment to request among the possible fragments based on a number of factors (e.g., how much media content is already downloaded and ready to play back streaming client media buffer, the current download conditions, etc.). The time at which UA 129 makes the next fragment request may influence which next fragment is requested from a possible set of next fragments. Accordingly, it may be advantageous for UA 129 to make the next fragment request at the latest point in time that will not slow down the download rate of fragments, as the UA may then have the most relevant information possible to select the next fragment.

A browser is another example configuration of UA 129 for which it may be advantageous for the UA to make the next fragment request as late as possible. In the case of a dynamic web page, the download of some objects may depend on the content of other objects downloaded. The download speed of the first objects may be used by the UA to determine which version of subsequent objects to download, where a version of an object may correspond to a different resolution or display fidelity and such different versions of objects might be different sizes. For example, a first object is slow to download, then UA 129 may decide to download a lower display resolution of a subsequent object instead of a larger but higher display resolution version of that subsequent object. Such operation may result in the overall user experience being better to display the lower resolution version of the object faster instead of the higher resolution version with more delay. On the other hand, UA 129 may decide to download a higher display resolution of a subsequent object if the download time for a first object is relatively fast, because the overall user experience will be higher when the user sees a high resolution version of the object displayed in an amount of time that is not unacceptable to the end user.

Embodiments of TA 120 therefore provide transport accelerator enhanced signaling operable to signal to UA 129 regarding times when fragment requests should be made. The time for a next fragment request may, for example, be the latest point in time where the download rate can continue at full speed without further fragment requests or suitable fragment requests. As explained in more detail below, RM 121 of embodiments signals UA 129 that the next fragment request should be made when it is time for the RM to provide another chunk request to CM 122 and there are no further chunk requests that the RM can make based on fragments already requested by the UA. Accordingly, CM 122 of embodiments correspondingly operates to provide signaling to RM 121 regarding when the CM is ready to make another chunk request to server 130 and CM 122 has further chunk request that the CM 122 has not already sent to the network or server 130 and thus is already in process.

From the foregoing, it can be appreciated that a tight data flow between UA 129, RM 121, and CM 122, with very little or no delay in timing of events within the RM and CM, may be desirable according to embodiments herein. For example, a CM of a multiple connection CM configuration (e.g., CM-mHTTP) may signal the ability to make another chunk request when the CM is ready to process another data request, whereby the CM immediately maps the data request to a connection and makes the request once the CM obtains the data request from the RM. Similarly, the RM may immediately signal the availability to process another fragment request to the UA when the RM does not have any data request that it can make to the CM based on previous fragment requests it has received from the UA and the CM indicates that it is ready to process another data request.

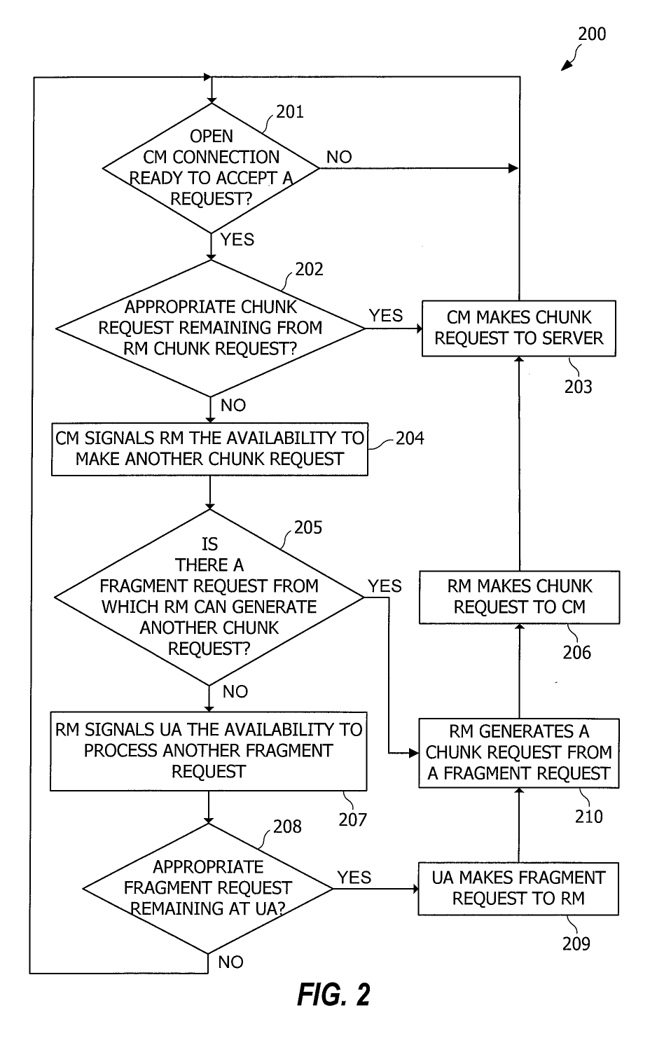

FIG. 2 shows exemplary operation of TA 120 providing transport accelerator enhanced signaling in the form of readiness signaling according to embodiments as flow 200. Processing in accordance with flow 200 of the illustrated embodiment provides a sequence of events that triggers RM 121 to signal to UA 129 that it is a good time to provide another fragment request. At block 201 a determination is made as to whether CM 122 has an open connection (e.g., open TCP connection) that is ready to accept another request (e.g., a HTTP request) for a chunk of content. If no connection at the CM is ready to accept another request, processing according to the illustrated embodiment loops back for detecting an open connection that is ready to accept another request. If, however, a connection at the CM is ready to accept another request, processing according to the illustrated embodiment proceeds to block 202.

At block 202 a determination is made as to whether CM 122 has an appropriate chunk request (e.g., a chunk request for which no request has yet been made to the content server by the CM, a chunk request having one or more attributes suitable for the open connection, such as size, type, priority designation, etc., and/or the like) remaining from the chunk requests provided thereto. In operation according to embodiments, the CM may be determined not to be ready for another chunk request from the RM if the CM is not currently able to immediately make the request for the chunk across the interface that the CM is using to provide the data chunks.

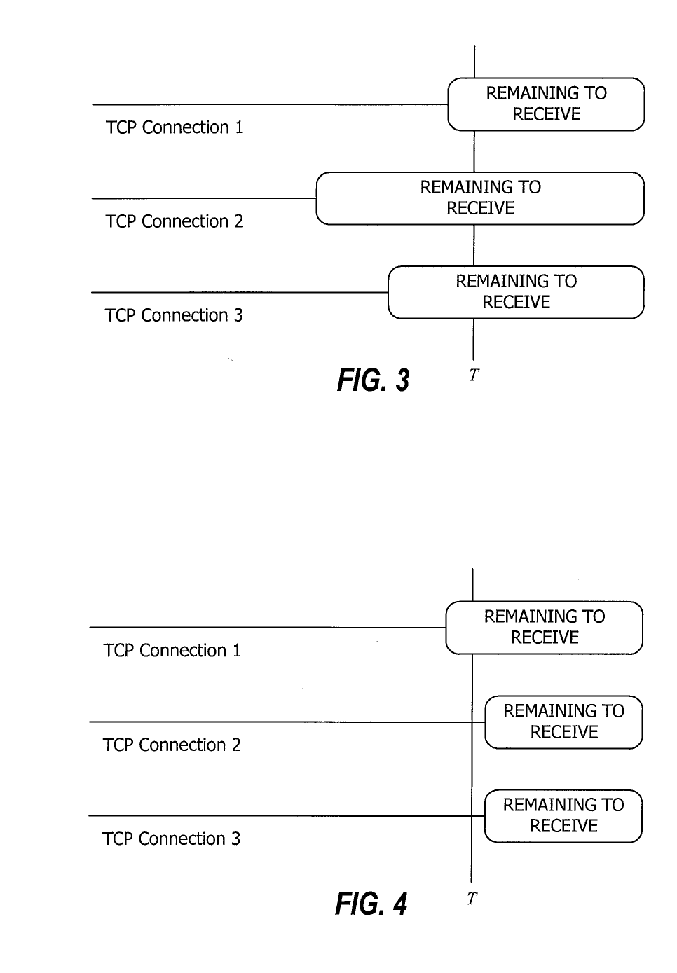

FIG. 3 illustrates an exemplary scenario where CM 122 is not currently able to immediately make a chunk request. In this example, it is assumed that the CM is ready for another chunk request on any particular connection when the amount of data left to receive for all current requests falls below a threshold amount, T (e.g., T may correspond to a configured buffer amount). For example, CM 122 may comprise the aforementioned CM-mHTTP configuration and may be utilizing the three TCP connections as shown in FIG. 3, wherein the CM has already made HTTP chunk requests for data on all three connections such that the amount of remaining data to be received on each of the three TCP connections is still above the threshold amount, T. In this scenario, the CM cannot currently make any more HTTP requests on any of these three connections. Accordingly, the CM is not ready for another chunk request from the RM, because even if the CM did receive another chunk request from the RM the CM could not immediately make a request for that chunk.

FIG. 4 illustrates an exemplary scenario where CM 122 is currently able to immediately make a chunk request. In this example it is again assumed that the CM is ready for another chunk request on any particular connection when the amount of data left to receive for all current requests falls below a threshold amount, T. In the example of FIG. 4, the amount of remaining data to be received for at least one of the connections (e.g., TCP connection 2 and TCP connection 3) is such that another request can be made. CM 122 may thus provide readiness signaling to RM 121 that the CM is ready for another chunk request from the RM. In the illustrated example, the CM may signal readiness for at least two more additional chunk requests, since the CM can immediately make a request for two connections (i.e., TCP connections 2 and 3).

As can be appreciated from the foregoing, when exactly the CM signals readiness or not may depend on one or more aspects of the CM implementation. For example, different algorithms may be utilized with respect to different CM configurations. For example, a CM not making use of pipelining may signal readiness when at least one connection is idle. Such an embodiment may control the maximum amount of data flowing on the network by signaling a smaller chunk request size. However, such a technique may not be optimum for use with respect to a CM configuration which implements pipelining. Where pipelining is implemented by the CM, a technique utilizing a threshold with respect to the amount of data left to receive on the connections, as described above, may be advantageous.

In some cases the exact number of connections available and used may not be known to the CM. For example, a CM of embodiments may be based on a HTTP library, which can issue requests and return received bytes, but which will schedule requests onto connections autonomously, and not in a transparent manner. Assuming the underlying HTTP library does not use pipelining, the following technique may be implemented with respect to such CM configurations.

Q:=Number of incomplete requests handed to the HTTP library.

R:=The number of incomplete requests for which a partial response has already been received.

If (Q<smin or Q=R) and Q<smax, signal readiness.

Otherwise do not signal readiness.

In the above algorithm, smin and smax are tuning constants. Smin indicates how many requests the CM should assume can be handled concurrently. Ideally, the value of smin should not be chosen to be larger than what the library can handle in reality. Smax is a maximum number of concurrent fragment requests to issue.

In operation according to the illustrated embodiment of flow 200, if an appropriate chunk request remains available at CM 122 as determined at block 202, processing according to the illustrated embodiment proceeds to block 203 where the CM makes the chunk request to the content server. CM 122 of embodiments may implement an application programming interface (API) to interface the CM with one or more interfaces over which the CM requests and receives data from server 130. The particular configuration of the API(s) implemented by CM 122 of embodiments depends upon the CM configuration and the interface types. Irrespective of the particular infrastructure for facilitating the communication, after having made the chunk request to the chunk server, processing of the illustrated embodiment loops back for detecting an open connection that is ready to accept another request. If, however, an appropriate chunk request is not available at CM 122, processing according to the illustrated embodiment proceeds to block 204 where the CM signals RM 121 to provide another chunk request.

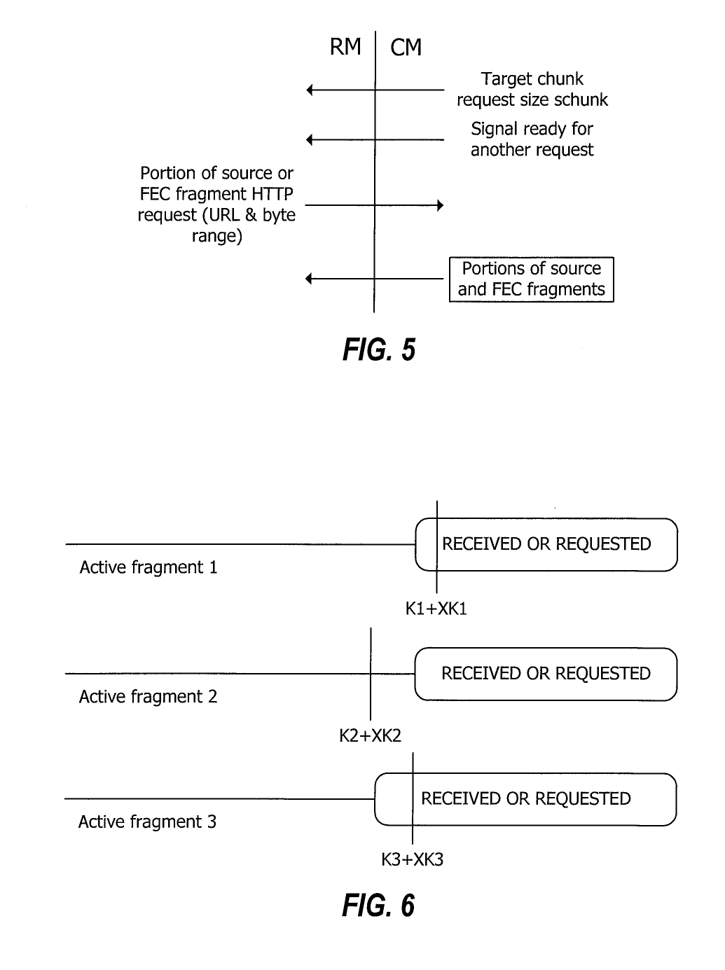

When CM 122 is ready for another chunk request from RM 121, the CM may initiate the aforementioned readiness signaling using a suitably configured API interfacing CM 122 and RM 122 as shown in FIG. 5. The basic API between RM 121 and CM 122 may comprise a HTTP 1.1 type of interface. It should be appreciated, however, that the API may include enhancements over such a standard interface, such as to facilitate the aforementioned transport accelerator enhanced signaling. Using such an API, the CM can signal to the RM when it is a good time to provide the next chunk request, where this signaling may be at the latest point in time where the CM having the next chunk request ensures the fastest download of data possible by the CM for the RM.

The API implemented between RM 121 and CM 122 may be adapted to facilitate the CM providing the RM with other information of value. For example, the API may facilitate the CM providing responses that include indications of byte ranges of the data returned to the RM in cases where the CM may provide partial responses to the RM. Additionally or alternatively, the API may facilitate inclusion of other information passed between the CM and RM, such as for the CM to provide the RM with an indication of the aggregate amount of data that has been downloaded together with a time stamp indicating when the measurement was taken. The RM can use this information for a variety of purposes, including deciding which portion of chunk requests to send to the CM when the RM is interfacing with multiple CMs. As another example, the RM may aggregate this information and provide it to a UA that is providing fragments to the RM, and the UA may use this to determine which fragments to provide to the RM in the future.

At block 205 a determination is made as to whether RM 121 has a fragment request received from the UA 129 for which the RM can generate chunk request (e.g., a chunk request for which no request has yet been made to the CM by the RM, a chunk request having one or more attributes suitable for the open connection, such as size, type, priority designation, etc., and/or the like). If RM 121 determines at block 205 that it is not ready for another fragment request from the UA because the RM can generate another chunk request from already received fragment requests, the processing proceeds to block 210 where the RM generates another chunk requests, and the RM can provide this chunk request to the CM at block 206.

An example of a situation where RM 121 may be determined not to be ready for another fragment request is shown in FIG. 6, wherein the RM is illustrated as having received three fragment requests from the UA that the RM has not yet completed. RM 121 may, for example, make another chunk request for a particular fragment when the amount of data received or requested but not yet received for that fragment falls below some threshold amount. For example, as shown in FIG. 6, if the fragment is K octets in size then another chuck request might be made whenever the amount of data received or requested but not yet received for the fragment is below K+XK, where XK is a configurable parameter that may depend on K. If FEC is not to be used to recover the fragment then generally XL=0, and thus a chunk request can be made for the fragment as long as some data for the fragment has not yet been received or requested. If FEC is to be used to recover the fragment then generally XK>0, and thus a chunk request can be made even when the amount of received plus requested but not yet received data exceeds the size of the fragment by an amount up to XK. In the situation illustrated in FIG. 6, RM 121 can still make chunk requests for the second of these fragment requests (active fragment 2) when CM 122 indicates it can receive another chunk request.

If an appropriate chunk request remains available at RM 121, as determined at block 205, processing according to the illustrated embodiment proceeds to block 206 where the RM makes the chunk request to CM 122. Thereafter, processing according to the illustrated embodiment proceeds to block 203 for operation wherein the CM makes the chunk request to the content server as discussed above.

If, however, an appropriate chunk request cannot be generated by RM 121, as determined at block 205, processing according to the illustrated embodiment proceeds to block 207 where the RM signals UA 129 to provide another fragment request from which chunk requests may be generated.

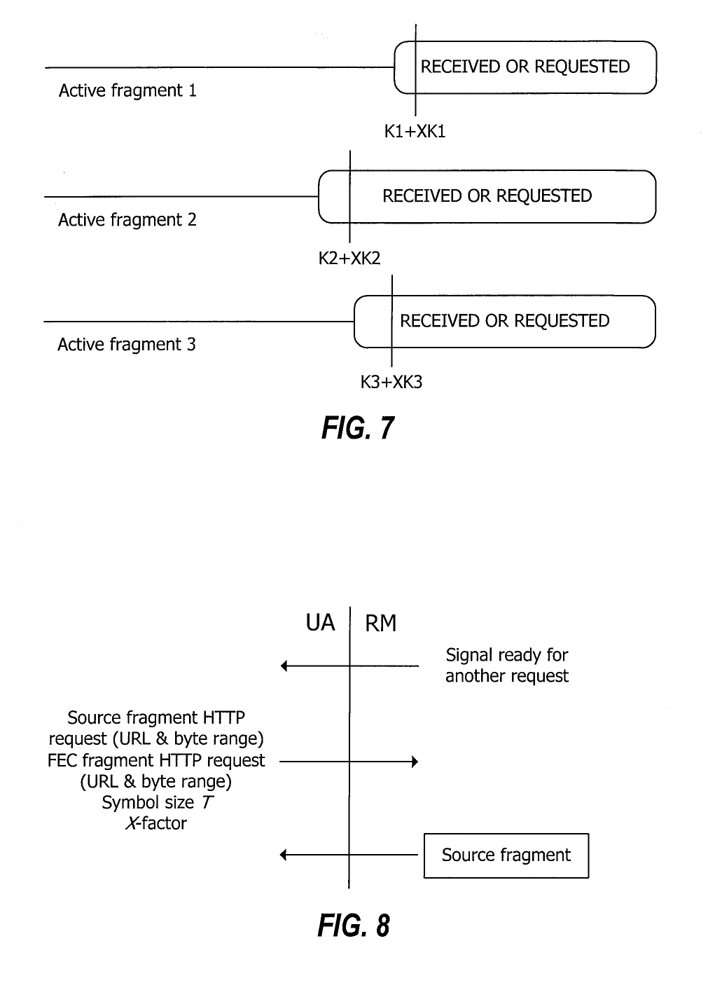

RM 121 may be determined to be ready for another fragment request from UA 129 where CM 122 has indicated to the RM that it is ready for another data chunk request and the RM has no already received fragment requests from the UA for which the RM can make another chunk request. An example of when the RM has not already received fragment requests from the UA for which the RM can make another chunk request is when the RM has not yet received any fragment requests from the UA. Another example of when the RM has not already received fragment requests from the UA for which the RM can make another chunk request is shown in FIG. 7. In the scenario illustrated in FIG. 7, RM 121 has received three fragment requests from UA 129 that the RM has not yet completed. However, the RM is not able to make any additional data requests for any of these three fragments at this point in time because the RM has requested from the CM as much data as allowed for each of these three fragments already. That is, continuing with the above example where the RM may make another chunk request for a particular fragment when the amount of data received for requested and unacknowledged for that fragment falls below some threshold amount (e.g., K+XK), each of the three active fragments illustrated in FIG. 7 have outstanding data requests in excess of a predetermined threshold amount.

Accordingly, when RM 121 is ready for another fragment request from UA 129, the RM may initiate the aforementioned readiness signaling of block 207, such as using a suitably configured API interfacing RM 121 and UA 129 as shown in FIG. 8. A basic API as may be implemented between the UA and the RM allows the UA to make fragment requests to the RM and to receive in response the fragments provided by the RM to the UA. Such a basic API may, for example, essentially comprise an HTTP 1.1 interface. However, an enhanced API, such as illustrated in FIG. 8 can be utilized to provide benefits associated with the aforementioned readiness signaling. Using such an API, the RM can signal to the UA when it is a good time to provide the next fragment request, where this signaling may be at the latest point in time where the RM having the next fragment request ensures the fastest continual delivery of fragments possible by the RM to the UA.

An API of embodiments utilized between the UA and the RM may be split into separate APIs, wherein some parts of the API are required by the UA to support and other parts of the API are optional for the UA to support. For example, a portion of an API facilitating the aforementioned readiness signaling may be optional for the UA to support, whereas a portion of an API facilitating making the fragment request may be required by the UA to support. Accordingly, the readiness signaling from the RM to the UA is completely decoupled from the UA to RM fragment request, according to embodiments, although the UA can use information received from the readiness signaling to determine the timing of when the UA makes the next fragment request. Thus, the API used for transport accelerator enhanced signaling (e.g., readiness signaling) may be optionally supported by the UA, while the API used for basic functions (e.g., fragment requests) may be the same, or essentially the same, as a standard (e.g., HTTP) API. This allows a UA to use the API providing basic functionality to make fragment requests to the RM, whether or not the API providing enhanced signaling is supported or used by the UA.

The foregoing readiness signals may be provided to the UA in a number of ways according to embodiments herein. For example, a readiness status message may be provided each time the UA and RM interact for any reason. In operation according to embodiments, RM 121 provides UA 129 a message during their interaction indicating either “yes, another fragment request would be good” or “no, another fragment request is not needed at this point in time, still working effectively on previous fragment requests”. Additionally or alternatively, UA 129 may operate to poll the readiness information from RM 121 explicitly. Likewise, RM 121 may operate to push the readiness information to UA 129.

At block 208 a determination is made as to whether UA 129 has an appropriate fragment request (e.g., a fragment request for which no request has been made to TA 120 by the UA, a fragment request having one or more attributes suitable for the open connection, such as size, type, priority designation, etc. and/or the like) remaining for any content stream for the client device. If no appropriate fragment request remains at the UA, processing according to the illustrated embodiment loops back to block 201. If, however, an appropriate fragment request remains at UA 129, processing according to the illustrated embodiment proceeds to block 209 where the UA makes the fragment request to RM 121.

Operation of TA 120 according to embodiments is adapted to support client devices which are adapted for operation to accelerate the delivery of the source fragment requests according to the concepts herein as well as to support generic or legacy client devices. Accordingly, a UA of embodiments may nevertheless provide fragment requests to the RM at any time independent of the fragment request readiness signaling. For example, the UA may provide fragment requests independent of the foregoing readiness signaling because the UA does not need to make dynamic decisions about which fragments to request and thus making the requests earlier than the signaled time does not adversely affect the UA. As another example, the UA may not have any more fragments to request for some period of time due to the nature of the client device application, and the UA may make the next fragment request later than the readiness time signaled by the RM.

However, enhanced capabilities may, for example, be provided where a UA is designed to support, interpret, and/or respond to fragment request readiness signals from the RM. For example, when the UA comprises a DASH streaming client, having the RM provide the foregoing readiness signaling regarding good times to provide fragment requests can be useful in requesting an instance of the content optimized for the present conditions experienced by the client device.

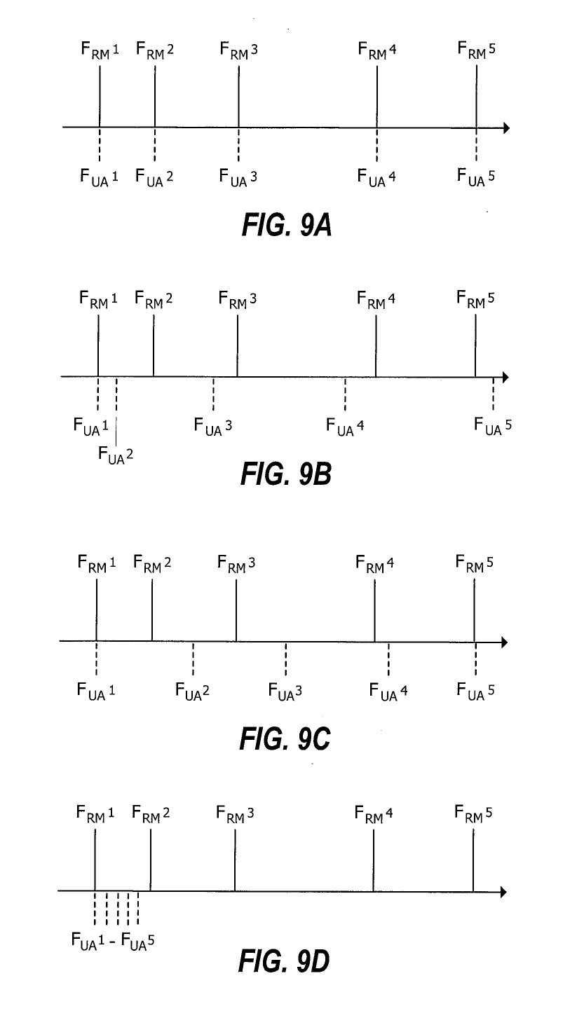

FIGS. 9A-9D provide examples of UA timing of fragment requests relative to the readiness signaling provided by the RM. In the illustrated examples, the timeline is shown running left to right from earlier points in time to later points in time, fragment request readiness signaling instances from the RM are represented by F_{RM}1-F_{RM}5, and fragment request instances from the UA are represented by F_{UA}1-F_{UA}5.

The example shown in FIG. 9A illustrates a scenario where UA 129 comprises an on-demand adaptive HTTP streaming client that uses an enhanced API to RM 121 to receive and process the readiness signals provided by the RM. It is assumed in this example that all of the fragments of the content are always available on server 130 and that there are multiple representations of the content available (e.g., each representation being for a different bit-rate version of the content). In operation according to the example illustrated in FIG. 9A, the UA only requests the next fragment when the RM indicates that it is ready for the next request. This operation allows the UA to choose the fragment encoded at the highest possible bit-rate among the possible fragments available for the next duration of playback that will allow download of that fragment before the time to start playback of the fragment. Making the UA fragment request at the point in time the RM indicates that it is ready for the next fragment request in this case is beneficial, as it allows the UA to make the decision at the latest point in time that will ensure that the RM achieves the highest download rate and provides the fragments to the UA as fast as possible, thus allowing the UA to make the best choice possible and still achieve the highest delivery rate of fragments to the UA.

Although embodiments of a UA may not support the foregoing readiness signaling, such a UA may nevertheless benefit from operation of a Transport Accelerator herein. For example, UA 129 of embodiments may only support a standard HTTP interface to TA 120, whereby the UA may ignore or not even receive the fragment request readiness signals. The example shown in FIG. 9B illustrates a scenario where UA 129 comprises an on-demand adaptive HTTP streaming client that does not use an enhanced API to RM 121 to receive and process the readiness signals provided by the RM (e.g., the UA may utilize a standard HTTP 1.1 interface to the RM which does not support readiness signaling). Without support for the readiness signaling, the UA may use different strategies for deciding when to supply the next fragment request to the RM. For example, the UA may implement a next fragment request strategy that ensures that there are always two outstanding fragment requests to the RM, and whenever the complete response for the earlier fragment request is provided by the RM to the UA the UA then issues the next fragment request to the RM. As illustrated in FIG. 9B, using such a strategy the UA may initially provide the RM with the first two requests (F_{UA}1 and F_{UA}2). At a point in time when the complete response is received by the UA for the first fragment (F_{UA}1) the UA provides the next fragment request (F_{UA}3) to the RM. It can be appreciated that the UA may sometimes provide a fragment request to the RM before the RM can start making data chunk requests for that fragment (e.g., requests F_{UA}2, F_{UA}3, and F_{UA}4). Nevertheless, the overall download speed of the requests is generally maximized, since the RM always has enough fragment requests to make data chunk requests when the CM is ready for the next data chunk request. However, the UA is making decisions for which fragment to request next earlier than necessary to guarantee a maximum download speed, which in some cases means that the UA may not make as good of a decision on which fragment to request next than it would have made at a later point in time. The UA may also sometimes provide a fragment request to the RM after the RM is ready to make data chunk requests for the next fragment (e.g., request F_{UA}5). In this case, the overall download speed of the requests may not be maximized, since the RM does not have a fragment from which to make another data chunk request when the CM is ready for the next data chunk request. However, the UA which does not support the readiness signaling is nevertheless supported and generally benefits from the operation of the Transport Accelerator.

The example shown in FIG. 9C illustrates a scenario where the UA that is an HTTP live streaming client. In a live streaming scenario, the fragments may be only available on the servers at fixed intervals of time (e.g., each fragment may be available on the HTTP web servers as soon as it is generated and may be made available for a limited window of time thereafter). In the illustrated example, it is assumed that each fragment comprises the streaming content for a fixed duration of real-time (e.g., two seconds of real-time). In such a live streaming scenario, it is typically not beneficial for the UA to download a fragment before it is available. Therefore, even if the RM indicates that it is ready for the next fragment request, the UA of the embodiment illustrated in FIG. 9C will not make the request for the next fragment until it is available on the servers.

The example shown in FIG. 9D illustrates a scenario where the UA comprises a browser accessing static web content, or pre-fetching static portion of a dynamic web page. In this scenario, the UA knows all of the files that it needs to download for the web-page when the web-page is first accessed, and thus there is no advantage for the UA to wait until the RM indicates when it is ready for the next fragment request. Accordingly, the UA of the illustrated embodiment operates to request the fragments (e.g., web objects) in the order that the UA wants the fragments returned for providing the best possible user experience. Accordingly, the aforementioned browser may not be adapted to take advantage of the readiness signaling from the RM (e.g., the browser may use a standard HTTP 1.1 interface to the RM).

It should be appreciated that the foregoing readiness signaling of embodiments is not tied to any other signaling (e.g., the readiness signaling may be independent of the basic API signaling). Accordingly, the UA of embodiments may make fragment requests to the RM without the UA supporting the readiness signaling. However, when the UA supports the readiness signaling from the RM, the UA of embodiments may nevertheless decide to ignore such signaling when making fragment requests. Thus, the RM may signal when it is ready for fragment requests, but the RM of embodiments does not accept or reject fragment requests based on this signaling. Accordingly, the request signaling may provide the UA with better information on when it is beneficial to make the next fragment request without restricting which fragment requests the UA can make to the RM and/or restricting the timing of any fragment requests that the UA makes to the RM.

Referring again to FIG. 2, in operation according to the illustrated embodiment of flow 200 illustrated in FIG. 2, after UA 129 makes the fragment request to RM 121 at block 209, processing proceeds to block 210 wherein RM 121 operates to generate at least one chunk requests from the fragment request (e.g., the first chunk request may be a small initial portion of the fragment). An appropriate chunk request may thereafter be provided by RM 121 to CM 122 at block 206, as described above.

From the foregoing it can be appreciated that, in operation according to embodiments, CM 122 may not have any data requests received from RM 121 that the CM is not processing, and RM 121 may not have any fragment requests received from UA 129 that the RM is not processing. Accordingly, the foregoing readiness signaling as implemented between CM 122 and RM 121 and as implemented between RM 121 and UA 129 facilitates the making of the next requests, whether a chunk request by the RM or a fragment request by the UA, at the latest point in time that will not slow down the download rate of content. Such readiness signaling implementations may, for example, allow the UA to have the most relevant information possible when selecting the next fragment.

Although exemplary embodiments have been described above whereby CM 122 provides readiness signaling to RM 121 and/or RM 121 provides readiness signaling to UA 129 in a “push” type signaling technique, embodiments may additionally or alternatively implement a “pull” type or querying based readiness signaling technique. For example, the readiness signaling of embodiments may be implemented through a querying approach whereby the RM queries the CM for readiness information. Likewise, the readiness signaling of embodiments may be implemented by the UA to querying the RM for the ability to issue a new fragment request.

The use of querying based readiness signaling techniques may be desirable in particular scenarios. For example, implementation of pull type signaling allows for a synchronous call flow and thus may be advantageous when operation of the UA would benefit from issuing more than one fragment request. The UA may issue a fragment request, and immediately query the RM if it is ready for another fragment request afterwards, according to an embodiment. The RM can consider the issued fragment request when making its decision regarding readiness for the next fragment request. Where the already issued request is very small (e.g., practically negligible), it may be advantageous to issue another fragment request. If, however, the issued request was large, the RM may not need a further request at this point.

In operation according to embodiments, the readiness queries and/or readiness signaling responsive thereto may include information beyond that utilized to directly query/indicate readiness. For example, the UA may provide an identifier of the resource to be requested when querying for readiness (e.g., a URI of the fragment). The RM of embodiments may use such fragment identifier information, perhaps in addition to other information regarding the state of the RM and/or requested data, to determine whether the RM is ready to receive a fragment request.

Additionally or alternatively, the RM may provide additional information in the signaling indicating readiness for a fragment request. For example, RM 121 may provide readiness signaling which indicates to UA 129 the aggregate number of fragment requests (AFR) that the RM can accept. Such AFR information may, for example, include all past fragment requests that RM 121 has already provided full responses to UA 129. In accordance with embodiments, RM 121 may signal that it is ready to accept another fragment request by incrementing the value of AFR (e.g., incrementing the AFR by one). Such a readiness signaling technique provides unambiguous information to the UA about whether or not the RM is ready for another fragment request. Accordingly, if the UA queries the RM several times over a short interval of time, the UA can distinguish between the case when the UA receives the same value of AFR in response to each query and when the UA receives increasingly larger values of AFR in response to such a sequence of queries. For example, if the UA has provided 35 fragment requests in total at some time t and the UA queries the RM at 3 subsequent times t1, t2 and t3 within a period of a few seconds, where the UA receives a response to each of the three queries that the AFR=36 then the UA can determine that the RM is ready for one additional fragment request at time t1 compared to the number at time t, and similarly the RM is ready for one additional fragment request at time t2 and time t3 compared to the number at time t (i.e., the RM does not become ready for more requests between time t1 and t3). However, if the UA receives responses from the three subsequent queries at times t1, t2 and t3 that the AFR=36, AFR=37, and AFR=38, respectively, then the UA can determine that the RM is ready for one additional fragment request at time t1 compared to the number at time t, and the RM is ready for one additional fragment request at time t2 compared to the number at time t1, and the RM is ready for one additional fragment request at time t3 compared to the number at time t2, i.e., the RM becomes ready for two more requests between times t1 and t3.

The information beyond that utilized to directly query/indicate readiness provided according to embodiments is not limited to the foregoing information nor is it limited to information to be passed between the UA and RM. Such additional information may, for example, be passed between the CM and RM, such as to be utilized by the RM and/or to be further passed by the RM to the UA. For example, a multiple connection CM configuration (e.g., CM-mHTTP) may have one or more connections open to a first server (Host A) and one or more connections open to a second server (Host B), whereby at any particular point in time it may be possible to send a request to Host A (or Host B) although it is not possible to send a request to Host B (or Host A). Accordingly, embodiments include information with the query and/or readiness signaling regarding the connection and/or server for which a request is made. Such information may be communicated between the CM and RM as well as between the RM and UA for use in determining which particular requests are to be made in response to a readiness signal. In operation according to embodiments, the CM can signal readiness for a request to a host (origin) server, except for a provided forbidden set of host (origin) servers. For example, if all available connections to host (origin) server A are currently occupied with requests and the CM is ready for a request to any other host server then the CM can signal readiness for another chunk request to the RM together with a set {A} of forbidden host servers. Thus, in response to this readiness signal the RM preferably provides a request to any host server other than to host server A. Later, when a connection to host server A becomes available to the CM for further requests, the CM can signal readiness for another chunk request to the RM without host server A on the forbidden set of host servers.

Transport accelerator enhanced signaling implemented according to embodiments may include signaling in addition to or in the alternative to the aforementioned readiness signaling. For example, embodiments herein may implement chunk request size signaling, such as to optimize content transfer bandwidth utilization. In such an embodiment, CM 122 may signal to RM 121 the size of requests that are suitable for the transport that the CM is providing, whereby the RM may use the supplied request size when it is forming chunk requests to make to the CM based on fragment requests received from UA 129.

For example, for a multiple connection CM configuration (e.g., CM-mHTTP), for a given connection (e.g., TCP connection) over which the next chunk request can be made, CM 122 may have the exact or approximate size of the amount of data, W, that the sender can immediately send over that connection at the time the request for the next chunk is received. Accordingly, CM 122 may signal the chunk request size as a minimum of W and Cmax, where Cmax is an upper bound on the desired chunk size request.

A reason for setting the desired chunk request size as described above is that, as soon as the sender (e.g., server 130) receives a request (e.g., HTTP request) of this size over the connection (e.g., TCP connection), the sender can immediately send the entire response over that connection. Thus, where all the chunk request sizes from the CM are selected in this way when making requests to the sender, and if all packets sent from the sender to the CM are received and received in order, then all data requested by the CM will arrive in order of when the CM made the requests, even when the CM is requesting the data over multiple TCP connections.

Chunk request size signaling implemented according to embodiments is additionally or alternatively useful when pipelining is not used. It should be appreciated that, in such a situation, the chunk size affects the performance. For example, if the RTT and the number of connections are fixed, the maximum achievable download rate is upper-bounded by a quantity linear in the chunk size. Thus, a chunk size appropriate to the particular content transfer environment may be calculated according to embodiments herein. The above referenced patent application entitled “TRANSPORT ACCELERATOR IMPLEMENTING REQUEST MANAGER AND CONNECTION MANAGER FUNCTIONALITY” provides additional detail with respect to computing an appropriate chunk size according to embodiments.

Transport accelerator enhanced signaling implemented according to embodiments may additionally or alternatively include download statistics (e.g., CM generated download statistics). For example, CM 122 may generate download statistics, such as current download rate, average download rate for particular connections and/or aggregated for a plurality of connections, etc., and provide those statistics to RM 121. RM 121 of embodiments may provide UA 129 with enhanced download rate statistics upon which the UA can base its fragment request decisions. For example, the RM can periodically provide the download rate statistics Z, Tr, and Tz, where Z is the total number of octets of data that has been downloaded, Tr is the amount of real-time over which this data has been downloaded, and Tz is the amount of this real-time wherein the download of fragments has been active, such as may be used by the UA to estimate the current download rate of fragments. Alternatively, for a UA configuration that does not support receiving and interpreting enhanced download statistics, such a UA may be adapted to determine download rate statistics, such as based on the rate at which the RM provides the UA with data responses.

Transport accelerator enhanced signaling implemented according to embodiments may additionally or alternatively include priority signaling. In operation according to embodiments, UA 129 may implement priority signaling to provide information to RM 121 about the priority of a fragment request relative to other fragment requests. For example, there may be three priority levels, wherein a fragment request of priority 1 is lowest priority, a fragment request of priority 2 is middle priority, and a fragment request of priority 3 is highest priority. UA 129 of embodiments may thus provide the priority of a fragment request to RM 121 when the UA provides the fragment request to the RM, whereby the RM may make the corresponding chunk requests to CM 122 based upon the priority level of the associated fragment request and, where the fragment requests are of the same priority level, the order in which the fragment requests were made/received. The chunk requests provided by RM 121 to CM 122 may additionally or alternatively include priority signaling. For example, where the CM may operate to queue or otherwise delay servicing chunk requests (e.g., where readiness signaling is not implemented), the RM may provide the priority of a chunk request to the CM when the RM provides the chunk request to the CM, whereby the CM may make the chunk requests to server 130 based upon the priority level and, where the chunk requests are of the same priority level, the order in which the chunk requests were made/received.

Rather than operating to download chunks associated with a same priority level in the order that the fragment/chunk requests were received, as described above, embodiments herein may implement relative associations for the requests within a priority level. For example, relative weighting may be implemented for requests within the same priory levels. Pending chunk requests within a same priority level may thus be requested and downloaded in accordance with their relative weighting. For example, if RM receives a request for fragment A from the UA with relative priority weight 2, and the RM receiver a request for fragment B from the UA with relative priority weight 1, then the RM may provide the CM with chunk request for fragments A and B in the proportion 2 chunk requests for fragment A for every 1 chunk request for fragment B.

Priority levels for fragments as may be signaled according to embodiments herein may be established based upon various criteria. For example, media type, file type, end application type, quality of service (QoS) objectives, etc. may be utilized for establishing priorities with respect to fragment requests and/or chunk requests.

In operation according to an embodiment, fragment requests associated with a video stream that is only displayed in a small portion of the display screen (e.g., a background video in a mosaic of videos being displayed, which is shown in a small thumbnail window) may be provided lower relative priority than a video stream that is displayed in a much larger portion of the display screen (e.g., the main video being viewed by the end user in a mosaic of videos being displayed, which is shown in a large main window).

As another example, in a webpage there may be some large static objects that are known to need to be downloaded when the end user first visits a webpage (e.g., a large picture that is to be displayed in the webpage), for which the browser can immediately make the fragment request to the RM when the webpage is first visited, even though the display of the picture does not have to be immediate within the webpage and thus the download of the fragment is lower priority. On the other hand, there may be other dynamic objects that need to be downloaded when the webpage is visited, wherein which objects are to be downloaded may depend on running a JavaScript piece of code to make the determination, or may require downloading other objects first to make the determination. In any case, there may be some time between when the webpage is first visited and when the browser can make the determination of which dynamic objects (fragments) that need to be requested from the RM, whereas these dynamic objects (fragments) are needed to properly render the webpage for the end user and thus are high priority fragments. Thus, when the browser makes the subsequent requests for these high priority fragments that correspond to dynamic objects, the RM may preempt the download of the lower priority fragment corresponding to the large picture and instead concentrate on downloading the high priority fragment corresponding to the dynamically determined objects.

As another example, a deployment scenario may be provided where a low end-to-end latency live video stream is to be delivered to a large audience of receivers. In this deployment, because of variability in available bandwidth to different receivers, the stream can be offered at different rates (e.g., 500 Kbps, 1 Mbps, 2 Mbps, 3 Mbps and 5 Mbps representations of the stream), and then receivers can dynamically choose at each point in time which of these representations to request and download. To ensure low end-to-end latency, each representation can be partitioned into fragments (e.g., one second duration fragments) wherein each fragment can be requested and played back by a UA 129 that is responsible for choosing at each fragment interval which fragment from which representation to request from the TA 120. Some challenges provided with respect to this deployment include there being very little time to download each fragment for playback (in order to maintain a low end-to-end latency), and thus it is difficult to estimate the appropriate representation to choose for each fragment interval (e.g., choose too high of a rate and there will be a stall, choose too low of a rate and the video quality will be lower than necessary). Furthermore, TCP is not very effective and ramping up its download speed over short intervals of tine (e.g., over 1 second of time). Since each fragment is available on a fixed time line it is generally not possible to download fragments from different time intervals in advance, or download multiple fragments from different time intervals in advance, or download multiple fragments from different time intervals in advance to build up the media buffer and to allow TCP download speed to ramp up.

The priority methods and other methods described herein can be used effectively to provide a good solution for the foregoing deployment. In one embodiment, UA 129 employs the following strategy for downloading video to playback for the next fragment interval [t, t+1]: based on an estimate of the current download speed R, the UA chooses a first fragment for the time interval [t, t+1] from a representation with playback rate R/2, and also a second fragment for the same time interval [t, t+1] from a representation with playback rate R, and also a third fragment for the same time interval [t, t+1] from a representation with playback rate 2·R, and provides these fragment requests in this order to TA 120. RM 121 of embodiments may thus generate chunk requests for these three fragments in the order the requests are made and provides them to CM 122 to receiver and provide responses back to RM 121, wherein RM 121 reconstructs the fragments from the responses and provides the fragments to UA 129 in the order of the requests, (i.e., the first fragment, the second fragment, and the third fragment). At some point the UA decides it is time to playback the content for the time interval [t, t+1], and it may be the case that not all three fragments may be provided to UA 129 by RM 121 by this point in time. At this point, UA 129 of embodiments provides the video player the fragment from the highest playback bit rate representation that it has been provided, i.e., the first fragment if only the first fragment is available, or the second fragment if the first and second fragments are available, or the third fragment if all three fragments are available. In addition, at this point in time UA 129 can signal to RM 121 that it should cancel the fragments for the time interval [t, t+1], and then RM 121 will not schedule a further chunk requests for these fragments, and will silently discard any further data received for these fragments.

When UA 129 makes fragment request to RM 121 for the next time interval [t+1. t+2], RM 121 of embodiments can classify the fragment requests for the time interval [t+1, t+2] as being higher absolute priority than the fragment requests for the time interval [t, t+1], and thus the RM will defer making any additional chunk requests for fragments from time interval [t, t+1] in preference to making chunk requests for fragments from time interval [t+1, t+2].

There are many advantages to the usage of priorities and cancellation methods as described for the disclosed embodiments of the deployment. For example, as long as not all of the chunk requests for fragments from time interval [t, t+1] are made by the time the fragment requests from time interval [t+1, t+2] arrive to the RM, the CM of embodiments will always be provided a chunk request when the CM indicates it is ready for a chunk request, (i.e., the download of data will be continuous and thus the TCP download rate will be able to ramp up to a high rate, which will lead to larger values of the measured download rate R than otherwise possible). Furthermore, the RM of embodiments seamlessly switches to making chunk requests for fragments from the next time interval as soon as they are ready to be requested, and the CM starts downloading these higher priority chunk requests with very little delay, thus ensuring with high likelihood that at least one of the fragments from the time interval [t+1, t+2] will be ready for playback when it is time to playback the stream for the time interval [t+1, t+2]. Also, since the UA of embodiments requests fragments that have playback rates that are far below as well as far above the current download rate estimate R, it is likely that at least the lowest playback rate fragment downloaded is available in time for playback, and generally the playback rate of the fragment that can be downloaded and played back is a significant fraction of the highest playback rate possible that could be downloaded in time at that point in time, thus providing a robust and high quality playback even when the download rate estimate R is inaccurate and highly variable.

There are many variations of the above embodiments. For example, instead of having independent representation of the video stream available, there might be a layered set of representations, such as those offered by a Scalable Video Coding version of H.264 or H.265. In this case, the fragment requests for each time interval might correspond to the different layers of the video in order of the dependency structure of the layers (from the base layer to higher quality layers, wherein the each higher quality layer depends on the lower layers for proper play back). For example, the UA may request three fragments for time interval [t, t+1], wherein the first fragment corresponds to a base layer, the second fragment corresponds to a first enhancement of the base layer, and the third fragment corresponds to a further enhancement of the first enhancement and the base layer. Then, if only the first fragment is downloaded in time for playback only this fragment is provided by the UA to the video player to produce a moderate quality playback, and if the first two fragments are downloaded in time for playback then both fragments are provided to the video player to be combined to produce a higher quality playback, and if all three fragments are downloaded in time for playback then all three fragments are provided to the video player to be combined to produce a highest quality playback.

As another example, there may be three bitrate versions of the content available: 256 Kbps (R1 version), 512 Kbps (R2 version), and 1 Mbps (R3 version). Assume that each segment covers a time interval of one second, so the segments from the three versions for time interval T (i.e., the time interval [T, T+1]) become available at some time T+X seconds, where X is a parameter that may be determined in part by how long it takes to make a segment available for download once it has started to be generated, and wherein S1_T, S2_T and S3_T are the segments corresponding to the R1, R2 and R3 versions of the content, respectively, in time interval T. A fetching technique employed by the UA may be a follows. When the segments for time interval T become available at time T+X seconds, the UA requests the segment S1_T from the R1 version of the content with priority 2000-T, the segment S2_T from the R2 version with priority 1000-T, and the segment S3_T from the R3 version with priority −T. At time T+X+delta (for some fixed, configurable delta), either S1_T, S2_T, or S3_T is provided by the UA to the media player for playback (e.g., whichever is the best quality segment that has been provided (completely downloaded and/or reconstructed) to the UA by the TA by time T+X+delta). Also, at time T+X+delta, the UA may indicate to the TA that any segment for time interval T that has not been fully received should be canceled. For example, if S1_T and S2_T are available to the UA by time T+X+delta, but S3_T is not fully available, then the UA may provide S2_T to the media player (since S2_T is the highest quality segment available) and the UA may indicate to the TA that S3_T should be canceled (since S3_T will not be played back). If no segment for time interval T was successfully provided to the UA by the TA by time T+X+delta, embodiments operate to provide a dummy segment S0 to the media player for playback, where S0 when played back shows a blank screen or a screen with a spinning circle that indicates rebuffering is occurring, and where the playback duration of S0 covers the time interval duration (i.e., 1 second of playback in the foregoing example). The dummy segment S0 may be a segment that may be provided to the UA by a download from a server related to the particular content being played back, it may be an ad, or it may be simply indicate rebuffering or stalling to the end user when played back. For example, in the context of DASH content, the MPD may provide a URL to a dummy segment S0 that is to be played back when there are no other segments for the content available to the UA to playback for a duration of time. Additionally or alternatively, the dummy segment S0 may be preloaded into the UA to be played back for any content when no other segment for a duration of time is available to the UA. The dummy segment S0 may be provided by the UA to the video or audio player with timing information adjusted, if necessary, to fit properly into the playback timeline. The playback duration of the dummy segment S0 may be adjusted by the UA to fit into the playback duration for which no other segments are available for playback. For example, segment S0 may correspond to the UA information the video player to freeze the last frame from the last segment for a specified duration of time, wherein the duration of time is time duration of segments for the content being played back. If more than one consecutive segment is not available to the UA, then the UA may indicate to the video player additional durations of time to continue to freeze the last available frame. As another example, segment S0 may correspond to an advertisement frame that is to be played back when no other segments are available, wherein the duration of the advertisement is adjusted by the UA to correspond to the duration of time when no other segment are available for playback. Additionally or alternatively, there may be a selection of advertisements frames, or advertisement videos, that the UA may provide to the player when no other segment for the content is available for playback. As another example, segment S0 may be a generic black frame with an indication that the play back is stalled (e.g., a video of a spinning wheel is displayed on top of the black frame). The advantages are that the UA can flexibly select an appropriate dummy segment S0 to provide to the video or audio player, the video or audio player is never starved for segments to playback and thus the video or audio player does not need to be robust to media starvation, the amount of network capacity and timing of download of content to playback during stalls is minimized, and the end user that is watching or hearing the playback is provided positive feedback about what is happening during stalls, resulting in a more satisfactory user experience.

As a special case, the very first segment might be provided by the UA to the media player with an additional delay (e.g., instead of the UA providing a segment for time interval 0 to the media player at time T+X+delta, the UA of this embodiment would provide a segment for time interval 0 to the media player at time T+X+delta+fudge_delay, where fudge_delay is a configurable parameter. Embodiments may include such an extra delay to make sure the video decoder is not starved at segment boundaries, and to allow for some decoding jitter.

In operation according to embodiments, such as the foregoing exemplary implementation, the segments for which the RM should generate chunk requests can change dynamically, such as based on the priorities of the segments provided to the RM by the UA. For example, at time X the RM may receive requests for the three segments S1_{—}0, S2_{—}0 and S3_{—}0 for time interval 0 from the UA, with respective priorities 2000, 1000 and 0. Thus, the segments within the RM listed in decreasing priority order are S1_{—}0, S20, and S3_{—}0, and the RM would generate chunk requests for any segment in this list only if there are no chunk requests that can be generated for earlier segments in this list at this point in time. At time 1+X the RM may receive requests for the three segments S1_{—}1, S2_{—}1 and S3_{—}1 for time interval 1 from the UA, with respective priorities 1999, 999 and −1. Thus, the segments listed in decreasing priority order are S1_{—}0, S1_{—}1, S20, S2_{—}1, S30, S3_{—}1, and the RM would generate chunk requests for any segment in this list only if there are no chunk requests that can be generated for earlier segments in this list at this point in time. If delta is at least 1 but at most 2, then at time X+delta the segments for time interval 0 would be canceled by the UA, in which case the priority ordered list within the RM would be S1_{—}1, S2_{—}1, S3_{—}1. Then, at time 2+X when the segments for time interval 2 are requested of the RM by the UA, the segments within the RM listed in decreasing priority order are S1_{—}1, S1_{—}2, S2_{—}1, S2_{—}2, S3_{—}1, S3_{—}2.

It should be appreciated that there are many variants of the foregoing technique, as may be implemented according to embodiments herein. For example, the UA may determine a different set of bit rate versions to request for each time interval, such as based upon measured previous download speeds (e.g., for time interval 1 the UA may request the segments corresponding to a 512 Kbps version, a 768 Kbps version, a 1025 Kbps version, and a 1500 Kbps version with respective priorities 1999, 999, −1 and −1001 (e.g., both the number of segments and which quality levels or bit rates of the content they correspond to can vary from one time interval to the next). As another variant, the priorities may be set to 0, −1, −2, etc. for the respective segments of versions of the content requested for a time interval, wherein the segment corresponding to the lowest bitrate version is assigned priority 0, the segment corresponding to the second lowest bitrate version is assigned priority −1, the segment corresponding to the third lowest bitrate version is assigned priority −2, etc. In this case, the TA may operate to determine which segment to generate the next chunk request for based first on highest priority for which there is a segment for which chunk requests can be generated, and then for segments of that same highest priority, the segment that was provided first to the TA.

Additionally or alternatively, the time interval duration may be different than the aforementioned exemplary one second interval. In accordance with embodiments, the time interval duration may vary over a range of times (e.g., the time interval duration may vary between 0.5 seconds and 1.5 seconds for different time intervals).

In operation according to embodiments, the content may be encoded in such a way that there is not a stream access point (SAP) at the beginning of each segment or fragment. For example, the duration of each fragment or segment of content may be 1 second, but only each third fragment or segment begins with a SAP and there are no other SAPs, and thus the duration of time between consecutive SAPs is 3 seconds. Such an embodiment allows much better video compression than if the duration between SAPs were 1 second. In this case, the download strategy employed by the UA could be the same as described above. However, a different playback strategy can be used by the UA. For example, the segments corresponding to time interval T may begin with a SAP, and thus there are no SAPs in the segments corresponding to time interval T+1 and time interval T+2. The player generally can playback segment Si_T+2 for time interval T+2 only if it has segments Si+T and Si_T+1. Thus, the playback strategy for the UA and player may be the following: For time interval T, suppose the UA has downloaded segments S0_T and S1_T by the time content for time interval T is to be played back. Then, the UA provides S1_T (i.e., the highest quality segment downloaded for time interval T) to the player for playback. For time interval T+1, suppose the UA has downloaded only segment S0_T+1 by the time content for time interval T+1 is to be played back. In this case, the UA can provide S0_T to a second player, and S0_T+1, and the second player is instructed to video decode S0_T+1 based on S0_T and playback the portion corresponding to S0_T+1 during time interval T+1. For time interval T+2, suppose the UA has downloaded segments S0_T, S1_T and S2_T by the time content for time interval T+2 is to be played back. In this case, since the UA does not have S1_T+1, S2_T+1, which is needed to video decode S1_T+2, S2_T+2, respectively, the UA can provide S0_T+2 to the second player, and the second player is instructed to video decode S0_T+2 based on S0_T and S0_T+1 and playback the portion corresponding to S0_T+2 during time interval T+2. Thus, the foregoing technique operates according to embodiments as follows for a consecutive sequence of time intervals T, T+1, . . . , T+N, wherein all segments corresponding to time interval T start with SAPs and there are no other SAPs in segments corresponding to these consecutive time intervals. For time interval T, the UA provides for playback the highest quality segment downloaded by the time content for time interval T is to be played back. In general, for time interval T+I (I<=N), the UA provides for playback the segment corresponding to the highest quality representation for which a segment for this representation has been downloaded for each time interval T, T+1, . . . , T+I by the time content for time interval T+I is to be played back. Generally, playing back the content according to this method may include running several player concurrently, up to the number N of players, and decoding the segment to be played back for a time interval based on segments from the same representation as that segment.

There are many variations of the above embodiments. For example, instead of having independent representation of the video stream available when segments do not start with SAPs for each time interval, there may be a layered set of representations, such as those offered by a Scalable Video Coding version of H.264 or H.265. In this case, the segment or fragment requests for each time interval may correspond to the different layers of the video in order of the dependency structure of the layers (e.g., from the base layer to higher quality layers, wherein the each higher quality layer depends on the lower layers for proper play back). For example, there may be three fragments available for download for each time interval, wherein the first fragment corresponds to a base layer, the second fragment corresponds to a first enhancement of the base layer, and the third fragment corresponds to a further enhancement of the first enhancement and the base layer. This technique operates according to embodiments as follows for a consecutive sequence of time intervals T, T+1, T+N, wherein all fragments corresponding to time interval T start with SAPs and there are no other SAPs in fragments corresponding to these consecutive time intervals. For time interval T, the UA provides for playback the highest quality fragment downloaded by the time content for time interval T is to be played back. In general, for time interval T+I (I<=N), the UA provides for playback all fragments for all time intervals T, . . . , T+I for all layers from the base layer up to the highest layer L for which a fragment for all layers up to layer L has been downloaded for each time interval T, T+1, T+I by the time content for time interval T+I is to be played back. Thus, generally the quality that is played back is the following: For time interval T, the quality corresponding to enhancement layer L, where L is the maximum value such that all fragments corresponding to time interval T from the base layer up to and including layer L have been downloaded by the UA by the time content is to be played back for time interval T. In general, if L′ is the quality of the content played back in time interval T+I, then the quality of the content played back in time interval T+I+1 is the minimum of L′ and L, where L is the maximum value such that all fragments corresponding to time interval T+I+1 from the base layer up to and including layer L have been downloaded by the UA by the time content is to be played back for time interval T+I+1. With this technique, the UA can provide a single copy of each fragment to be used for playback to a single player, and the player can decode the content for the time interval to be played back based on decoded fragments for previous time intervals and based on fragments provided to the player by the UA corresponding to the time interval to be played back.

In another variation, the UA may indicate to the TA that some segment requests already provided to the TA should be paused. In operation according to embodiments, when the UA indicates that a segment request is to be paused, the RM component of the TA refrains from issuing any further chunk requests generated from the paused segments to the CM. Then, at a later time the UA may indicate to the TA that some of the paused segments should be resumed, whereby in the foregoing exemplary embodiment the RM may start again issuing chunk requests generated from these resumed segment to the CM. This situation may be beneficial for example when the end user pauses playback of video at some point in time, and then resumes playback at some later point in time, in which case it can be beneficial for the UA to pause any active segments already provided to the TA when the UA receives the signal that playback is paused, and for the UA to resume any paused segments already provided to the TA when the UA receives the signal that playback has resumed.

Another example of when pausing and resuming of segments already provided by the UA to the TA can be beneficial is when for whatever reason the UA stops accepting segment responses from the TA. In such a case the TA of embodiments may pause downloads of existing segments that are to be provided to such a UA in order to minimize the amount of data that is buffered within the TA and not yet delivered to UAs. However, if the UA starts accepting segment responses again from the TA then the TA may resume any paused segments for this UA. In operation according to embodiments, if the UA does not start accepting responses for some large period of time, or the UA is disconnected from the TA or is otherwise not present for any reason, then the TA can cancel any remaining segment requests for such a UA.

Additionally or alternatively, state and/or special status information may be utilized for establishing priorities with respect to fragment requests and/or chunk request. For example, where missing data for a fragment of chunk is being re-requested, such request may be made at a higher (e.g., highest) priority level as may be signaled according to foregoing. As another example, fragment requests associated with certain content of a web page being viewed by a user (e.g., particular content the user has selected) may be given priority over other content of the web page (e.g., general content being downloaded to fill/complete the web page). As yet another example, determinations regarding the download completion time for fragments may be utilized in determining a priority level, such as may be used to provide faster start-up, avoid potential stall when the media buffer is low, etc.

Priority levels as utilized according to embodiments may be predetermined, such as through profile information provided when configuring the system, or some portion thereof, to designate particular types (e.g., file types, media types, application types, file size, etc.) as certain priorities or relative priorities, to designate certain states, statuses, events, etc. as associated with certain priorities or relative priorities etc. Additionally or alternatively, logic of UA 129 and/or RM 121 may operate to analyze fragment/chunk requests, state information, network conditions, operational parameters, etc. to determine certain priorities or relative priorities for fragment and/or chunk requests. It should be appreciated from the foregoing that priority information may be provided explicitly by the UA (or end application) or priority information may be derived within the transport accelerator of embodiments herein. Moreover, the priority information may be determined through a combination of priority designations by the UA and priority determinations by the transport accelerator. For example, the UA may designate a fragment request as higher priority than certain other fragment requests made by the UA, such as based upon the application type or media type, while the RM may finally designate the priority level of the corresponding chunk requests based upon network conditions or other considerations.

As discussed above, the chunk requests implemented according to embodiments herein are typically relatively small and thus do not take long to download relative to the entire fragment that is being requested. Generally, not all chunk requests for a particular fragment are generated or provided by the RM to the CM at the same time (e.g., a first fragment provided to the RM may generate a plurality of chunk requests which are provided to the CM one at a time over a period of time). Accordingly, the UA may make a higher priority fragment request at a later point in time whereby the RM usurps the remaining chunk requests for the prior, lower priority fragment request in favor of making chunk requests from the higher priority fragment request. Usurpation of the chunk requests of the lower priority fragment request may comprise the RM simply not making any more chunk requests for the lower priority fragment and instead making chunk requests for the higher priority fragment until all chunk requests for the higher priority fragment have been made. Thereafter, the RM may return to completing the download of the lower priority fragment by making any additional chunk requests for that fragment, assuming no other higher priority fragment request remains unserviced.

Request usurpation implemented in accordance with priority signaling of embodiments herein operates to not make any more chunk requests for the lower priority fragment(s) until the chunk requests for the higher priority fragment(s) have been made, although generally letting already requested but not yet completed lower priority chunk requests to complete (i.e., not cancelling the lower priority chunk requests). The aforementioned already requested lower priority chunk requests will typically finish downloading in a relatively brief period of time (e.g., chunk requests of embodiments are small relative to the size of the fragment). Accordingly, making higher priority chunk requests in accordance with embodiments herein does not require tearing down of connections (e.g., a TCP connection upon which lower priority chunk requests have been made) to implement the priority content transfer. Such operation to avoid cancelling chunk requests is advantageous according to embodiments herein as cancelling generally involves tearing down the connection, which is expensive and/or inefficient in terms of communication resource utilization.

Alternative embodiments may operate to implement one or more fairness algorithms with respect to the various priority levels, such as to avoid complete usurpation, and thus starving a lower priority level content stream. For example, a fairness algorithm may be implemented whereby only a certain percentage of the available bandwidth (e.g., 80% or 90%) is allowed to be consumed by the higher priority level requests, and thus a remaining percentage of the available bandwidth (e.g., 20% or 10%) is utilized to continue to serve lower priority requests during usurpation operation for serving higher priority requests.

Although embodiments have been described above wherein priority signaling is utilized to usurp lower priority chunk requests in favor of higher priority chunk requests, embodiments may nevertheless operate to cancel ongoing chunk requests and/or the associated fragment request according to operation herein. For example, RM 121 may operate to cancel chunk requests where a particular higher priority chunk request is received, such as where the higher priority chunk request is associated with a fragment which renders the fragment associated with the lower priority chunk request obsolete or otherwise undesirable (e.g., the lower priority chunk request is associated with an alternative fragment to that associated with the higher priority chunk request, the lower priority chunk request becomes stale due to the download of the chunks of the higher priority fragment request, etc.). UA 129 may operate to indicate to RM 121 that the fragment request should be cancelled, in which case the RM of embodiments does not issue any more chunk requests to CM 122 for that fragment, and may further instruct the CM to cancel requests that the RM has already made to the CM for chunks of that fragment. However, generally already issued requests are expensive to cancel, since the entire connection upon which the request is being processed typically has to be torn down and then reestablished for future requests. Thus it is generally more effective to let such chunk requests complete and have the RM silently discard any received data for canceled fragment requests that are received subsequent to when the UA issues the cancellation. Thus, the API implemented between the UA and the RM according to embodiments may comprise a mechanism for signaling cancelation of fragment requests (e.g., without specifying the method of how the RM should process the cancellation requests). Generally the RM will not provide any further data to the UA for a fragment subsequent to the time when the RM receives the cancellation request from the UA. Cancelling of requests according to embodiments may be temporary. Accordingly, RM 121 may operate to re-issue a cancelled chunk request either partially or in its entirety after the chunk requests of a higher-priority fragment request are received in full.

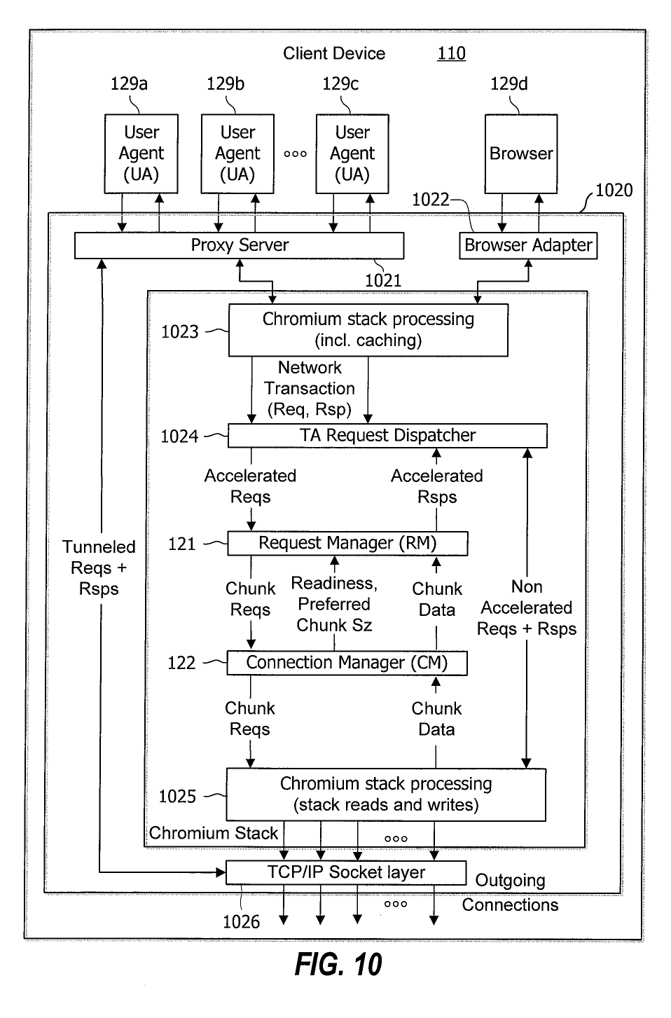

Although RM 121 of embodiments may generally provide responses to fragment requests in the order they are made by UA 129, within fragment requests of the same priority, in some situations the UA may change its decision and wish to cancel a request after the request has been made to the RM. However, this is not necessarily the case. There are use cases wherein the TA is configured as a proxy server for an APP (e.g., an application, applet, or other program), and wherein the TA is used by a browser, such as shown in the exemplary embodiment illustrated in FIG. 10.

FIG. 10 illustrates an embodiment implementing a Transport Accelerator proxy, shown as TA proxy 1020, with respect to client device 110. The illustrated embodiment of TA proxy 1020 includes RM 121 and CM 122 operable to generate chunk requests and manage the requests made to one or more servers for desired content, as described above. Moreover, TA proxy 1020 of the illustrated embodiment includes additional functionality facilitating proxied transport accelerator operation on behalf of one or more UAs according to the concepts herein. For example, TA proxy 1020 is shown to include proxy server 1021 providing a proxy server interface with respect to UAs 129a-129c. TA proxy 1020 of the illustrated embodiment is also shown to include browser adapter 1022 providing a web server interface with respect to UA 129d, wherein UA 129d is shown as a browser type user agent (e.g., a HTTP web browser for accessing and viewing web content and for communicating via HTTP with web servers). In addition to the aforementioned functional blocks providing a proxy interface with respect to UAs, the embodiment of TA 1020 illustrated in FIG. 10 is shown including additional functional blocks useful in facilitating accelerated transport of content according to the concepts herein. In particular, TA 1020 is shown as including stack processing 1023, TA request dispatcher 1024, stack processing 1025, and socket layer 1026. Further detail with respect to embodiments of TA proxy configurations is provided in the above referenced patent application entitled “TRANSPORT ACCELERATOR IMPLEMENTING A MULTIPLE INTERFACE ARCHITECTURE.”

When the TA is configured as a proxy server for an APP, typically on each connection the APP makes to the proxy the order of the requests made should be the order in which the response are made, and in this case it makes sense that each connection is assigned a priority (relative or absolute). When the TA is used by a browser then there is generally no assumed relationship between the order in which requests are made to the TA by the browser and the order in which responses are provided, and in this case it makes sense that each fragment request is assigned a priority. Thus within the RM, there should be a queue (e.g., RQs 191a-191c of FIG. 1B) for each connection when an APP is using the RM, and there should be a queue for each fragment request when a browser is using the RM.

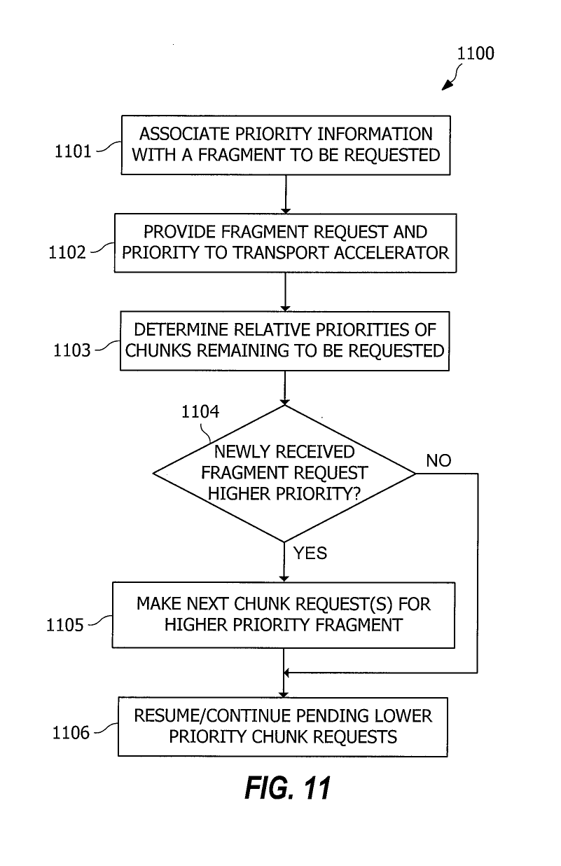

FIG. 11 illustrates exemplary operation of TA 120 providing transport accelerator enhanced signaling in the form of priority signaling according to embodiments as flow 1100. Processing in accordance with flow 1100 of the illustrated embodiment provides operation in which UA 129 provides fragment priority information signaling to RM 121 and/or RM 121 provides chunk priority information signaling to CM 122.

At block 1101, UA 129 operates to associate priority information with a fragment to be requested. As described above, relative priorities may be predetermined, such as based upon file types, application types, media types, etc. Additionally or alternatively, UA 129 may operate to determine relative priorities dynamically, such as based upon use conditions, network conditions, media buffer status, etc. As described above, RM 121 may operate to derive priority information (e.g., independent of priority information provided by UA 129). Accordingly, it should be appreciated that operation by UA 129 to associate priority information with a fragment to be requested according to the processing of block 1101 may be omitted (optional) according to embodiments herein.

At block 1102 of the illustrated embodiment, UA 129 provides a next fragment request to TA 120 (e.g., to RM 121 of TA 120). Where UA 129 operates to associate priority information with the fragment being requested, UA 129 of the illustrated embodiment provides the priority information in or in association with the fragment request for use by TA 120 in implementing priority transfer of content.

TA 120 operates to determine the relative priorities of chunks to be requested from the content server at block 1103. For example, RM 121 may generate chunk requests from the fragment request received from UA 129. Priority information associated with these generated chunk requests may be analyzed with respect to chunk requests for other fragment requests which have not been completed by RM 121 to determine relative priorities. Additionally or alternatively, RM 121 may analyze the fragment requests and/or information regarding the underlying data (whether alone or in combination with priority information provided by UA 129) to itself determine relative priorities at block 1103.

A determination is made at block 1104 as to whether the newly received fragment request has a higher priority level than fragment requests currently being served by TA 120. For example, logic of RM 121 may operate to compare priorities associated with the various chunk requests to determine if the chunk requests associated with the newly received fragment request is higher than that of other fragment requests pending at the RM. If the priority level associated with the newly received fragment request is not higher than the fragment requests currently being served by the TA, processing according to the illustrated embodiment proceeds to block 1106 to continue serving the fragment requests without usurpation or cancellation of their associated chunk requests, which includes requests generated from previous fragments and the new fragments. However, if the priority level associated with the newly received fragment request is higher than the fragment requests currently being served by the TA, processing according to the illustrated embodiment proceeds to block 1105.

At block 1105 of the illustrated embodiment, RM 121 operates to provide CM 122 next chunk requests those generated from the new higher priority fragment as the next chunk requests instead of chunk requests generated from the previously received lower priority fragments. For example, as described above, RM 121 may simply cease to make chunk requests for lower priority fragments until all chunk requests for higher priority fragments have been fulfilled. Additionally or alternatively, RM 121 may cancel lower priority chunk requests, such as by providing priority information to CM 122 to facilitate the CM cancelling particular chunk requests in favor of other chunk requests provided by the RM.

After the higher priority requests have been fulfilled, processing according to the illustrated embodiment proceeds to block 1106 to resume serving the usurped and/or cancelled requests. For example, where lower priority chunk requests have been ceased in favor of higher priority chunk requests, RM 121 may resume requesting the lower priority chunks. Where lower priority chunk requests have been cancelled and the unobtained chunks are nevertheless to be provided to UA 129, RM 121 may again request the cancelled chunk requests from CM 122.

It can be appreciated that chunk requests of higher priority level fragments are to be served expeditiously according to embodiments herein. Accordingly, even where readiness signaling is implemented, embodiments of RM 121 may operate to provide high priority level chunk requests to CM 122 without substantial delay. Such operation according to embodiments may result in unsolicited high priority chunk requests being provided to the CM.

CM 122 may, for example, receive unsolicited chunk requests (e.g., chunk requests that are generated from high priority fragment requests) at a time when the CM currently has no connections that can be used to make additional requests. Accordingly, CM 122 of embodiments operates to open up additional connections to server 130 in order to make requests for these unsolicited chunk requests, thereby facilitating downloading of these chunk requests immediately.

It should be appreciated, however, that it typically takes several round trip times to open a connection. Accordingly, chunk requests may be issued faster if they are issued on existing connections. For the purpose of scheduling, CM 122 of embodiments may keep a priority queue of chunk requests to be issued, such as may be sorted lexicographically by priority and issue time pairs. Such a priority queue may be utilized by the CM to make chunk requests using existing connections in accordance with the priorities. However, CM 122 may nevertheless use a high volume or requests to be serviced as an indication to open new connections. Whether these new connections would then be used for the high priority requests or lower priority requests may depend upon various considerations, such as how fast the connections opened compared the time it took to drain the pipe. In operation according to this technique, the chunk request is only bound to a connection when it is being issued, and not before.

Transport accelerator enhanced signaling implemented according to embodiments may additionally or alternatively include FEC signaling. For example, UA 129 may provide FEC signaling to RM 121 for utilizing FEC data with respect to the transfer of content. In operation, the UA may provide the RM with information about a FEC fragment matching the original source fragment being requested, wherein such FEC signaling may include additional parameters (e.g., an urgency or aggressiveness parameter useful in determining the extent of FEC information to be requested). In embodiments of a transport accelerator using an RM with FEC, the UA provides the RM with a source fragment request, a matching FEC fragment request, and an urgency factor, X, that indicates how aggressively the RM should request data beyond the minimal needed to recover the source fragment. In operation, RM 121 may provide just the source fragment, not the matching FEC fragment, to UA 129 in response. The UA, however, may nevertheless provide the RM with the matching FEC fragment request, and possibly additional information such as the aforementioned factor X, in order that the RM can use FEC data to help accelerate the delivery of the source fragment requested. That is, by requesting chunks of the source fragment and some amount of data from the corresponding FEC fragment, the RM need only receive enough data (whether from the source fragment chunks, from the FEC fragment, or a combination thereof, whatever arrives at the RM earliest) to recover the fragment. It should be appreciated that in the foregoing embodiment the RM is the only component that needs to understand the semantics of FEC, including providing FEC decoding.

In accordance with an alternative embodiment transport accelerator using an RM with FEC, the UA may provide the RM with only source fragment requests. In such an embodiment, the RM may derive the corresponding matching FEC fragment requests automatically. Additionally or alternatively, the RM may compute how much FEC to request for each fragment automatically.

Although selected aspects have been illustrated and described in detail, it will be understood that various substitutions and alterations may be made therein without departing from the spirit and scope of the present invention, as defined by the following claims.

What is claimed is:

1. A method for accelerating, by a transport accelerator (TA), delivery of content to a user agent (UA) of a client device, the method comprising:
subdividing, by a request manager (RM) of the TA, a fragment request provided by the UA into a plurality of chunk requests for requesting chunks of the content; and
signaling, by a connection manager (CM) of the TA to the RM, that the CM is ready for an additional chunk request of the content.

2. The method of claim 1, further comprising:
signaling, by the RM to the UA in response to the additional chunk request signaling by the CM, that the RM is ready for an additional fragment request.

3. The method of claim 2, wherein the RM accepts fragment requests from the UA independent of the signaling that the RM is ready for an additional fragment request.

4. The method of claim 2, further comprising:
determining, by the RM, if a chunk request of the plurality of chunk requests remains to be provided to the CM in response to the signaling that the CM is ready for an additional chunk request, wherein if no chunk request of the plurality of chunk requests remains to be provided to the CM the signaling that the RM is ready for an additional fragment request is initiated.

5. The method of claim 1, further comprising:
determining, by the CM, that the CM is immediately able to make a request for a chunk of content across one or more interfaces used by the CM to request chunks of the content, wherein the signaling that the CM is ready for an additional chunk request is performed in response to the determining.

6. The method of claim 1, wherein the signaling that the CM is ready for an additional chunk request of the content is specific to a host content server, and wherein each host content server of a plurality of host content servers from which the CM makes requests for chunks of content has its own readiness signal.

7. The method of claim 1, wherein the signaling that the CM is ready for an additional chunk request of the content is provided in response to a readiness query from the RM to the CM.

8. The method of claim 1, further comprising:
providing, by the RM to the CM in response to the signaling that the CM is ready for an additional chunk request, an additional chunk request requesting a corresponding chunk of the content.

9. The method of claim 8, further comprising:
determining, by the RM, a priority of chunk requests, wherein the additional chunk request provided by the RM to the CM in response to the signaling that the CM is ready for an additional chunk request comprises a highest priority chunk request available to the RM.

10. The method of claim 9, wherein priority information used by the RM in determining the priority of chunk requests is provided by the UA in association with a fragment request provided to the RM by the UA, wherein the priority information indicates a priority of the fragment request relative to other fragment requests.

11. The method of claim 9, wherein the RM determines the priority of chunk requests based upon one or more attributes of the fragment requests.

12. The method of claim 1, further comprising:
signaling, by the RM to the UA, download rate information adapted to facilitate estimation of a current download rate of fragments and determination of when fragments are to be requested by the UA.

13. The method of claim 12, wherein the download rate information comprises a total number of octets of data that has been downloaded (Z) and an amount of real-time over which the data has been downloaded (Tr).

14. An apparatus for accelerating, by a transport accelerator (TA), delivery of content to a user agent (UA) of a client device, the apparatus comprising:
means for subdividing, by a request manager (RM) of the TA, a fragment request provided by the UA into a plurality of chunk requests for requesting chunks of the content; and
means for signaling, by a connection manager (CM) of the TA to the RM, that the CM is ready for an additional chunk request of the content.

15. The apparatus of claim 14, further comprising:
means for signaling, by the RM to the UA in response to the additional chunk request signaling by the CM, that the RM is ready for an additional fragment request.

16. The apparatus of claim 15, wherein the RM accepts fragment requests from the UA independent of signaling that the RM is ready for an additional fragment request.

17. The apparatus of claim 15, further comprising:
means for determining, by the RM, if a chunk request of the plurality of chunk requests remains to be provided to the CM in response to signaling that the CM is ready for an additional chunk request, wherein if no chunk request of the plurality of chunk requests remains to be provided to the CM signaling that the RM is ready for an additional fragment request is initiated by the means for signaling.

18. The apparatus of claim 14, further comprising:
means for determining, by the CM, that the CM is immediately able to make a request for a chunk of content across one or more interfaces used by the CM to request chunks of the content, wherein signaling that the CM is ready for an additional chunk request is performed in response to the determining.

19. The apparatus of claim 14, wherein signaling that the CM is ready for an additional chunk request of the content is specific to a host content server, and wherein each host content server of a plurality of host content servers from which the CM makes requests for chunks of content has its own readiness signal.

20. The apparatus of claim 14, wherein signaling that the CM is ready for an additional chunk request of the content is provided in response to a readiness query from the RM to the CM.

21. The apparatus of claim 14, further comprising:
means for providing, by the RM to the CM in response to signaling that the CM is ready for an additional chunk request, an additional chunk request requesting a corresponding chunk of the content.

22. The apparatus of claim 21, further comprising:
means for determining, by the RM, a priority of chunk requests, wherein the additional chunk request provided by the RM to the CM in response to signaling that the CM is ready for an additional chunk request comprises a highest priority chunk request available to the RM.

23. The apparatus of claim 22, wherein priority information used by the RM in determining the priority of chunk requests is provided by the UA in association with a fragment request provided to the RM by the UA, wherein the priority information indicates a priority of the fragment request relative to other fragment requests.

24. The apparatus of claim 22, wherein the RM determines the priority of chunk requests based upon one or more attributes of the fragment requests.

25. The apparatus of claim 14, further comprising:
means for signaling, by the RM to the UA, download rate information adapted to facilitate estimation of a current download rate of fragments and determination of when fragments are to be requested by the UA.

26. The apparatus of claim 25, wherein the download rate information comprises a total number of octets of data that has been downloaded (Z) and an amount of real-time over which the data has been downloaded (Tr).

27. A computer program product for accelerating, by a transport accelerator (TA), delivery of content to a user agent (UA) of a client device, the computer program product comprising:
a non-transitory computer-readable medium having program code recorded thereon, the program code including:
program code to subdivide, by a request manager (RM) of the TA, a fragment request provided by the UA into a plurality of chunk requests for requesting chunks of the content; and
program code to signal, by a connection manager (CM) of the TA to the RM, that the CM is ready for an additional chunk request of the content.

28. The computer program product of claim 27, further comprising:
program code to signal, by the RM to the UA in response to the additional chunk request signaling by the CM, that the RM is ready for an additional fragment request.

29. The computer program product of claim 27, further comprising:
program code to determine, by the CM, that the CM is immediately able to make a request for a chunk of content across one or more interface used by the CM to request chunks of the content, wherein signaling that the CM is ready for an additional chunk request is performed in response to the determining.

30. The computer program product of claim 27, further comprising:
program code to provide, by the RM to the CM in response to the signaling that the CM is ready for an additional chunk request, a chunk request requesting a corresponding additional chunk of the content; and
program code to determine, by the RM, a priority of chunk requests, wherein the additional chunk request provided by the RM to the CM in response to the signaling that the CM is ready for an additional chunk request comprises a highest priority chunk request available to the RM.

31. An apparatus for accelerating, by a transport accelerator (TA), delivery of content to a user agent (UA) of a client device, the apparatus comprising:
at least one processor; and
a memory coupled to the at least one processor,
wherein the at least one processor is configured:
to subdivide, by a request manager (RM) of the TA, a fragment request provided by the UA into a plurality of chunk requests for requesting chunks of the content; and
to signal, by a connection manager (CM) of the TA to the RM, that the CM is ready for an additional chunk request of the content.

32. The apparatus of claim 31, wherein the at least one processor is further configured:
to signal, by the RM to the UA in response to the additional chunk request signaling by the CM, that the RM is ready for an additional fragment request.

33. The apparatus of claim 31, wherein the at least one processor is further configured:
to determine, by the CM, that the CM is immediately able to make a request for a chunk of content across one or more interface used by the CM to request chunks of the content, wherein the signaling that the CM is ready for an additional chunk request is performed in response to the determining.

34. A method for accelerating, by a transport accelerator (TA), delivery of content to a user agent (UA) of a client device, the method comprising:
receiving, by a request manager (RM) of the TA from the UA, fragment requests for requesting chunks of the content, wherein priority information is provided by the UA in association with the fragment requests, wherein the priority information indicates a priority of a corresponding fragment request relative to other fragment requests;
subdividing, by the RM, the fragment requests each into a plurality of chunk requests; and
providing, by the RM to a connection manager (CM) of the TA, chunk requests of the plurality of chunk requests in accordance with a priority of the fragment requests from which the chunk requests were subdivided.

35. The method of claim 34, wherein the providing chunk requests in accordance with the priority of the fragment requests comprises:
providing chunk requests of a fragment request having a higher priority than another fragment request to the CM by the RM prior to remaining chunk requests of the another fragment request.

36. The method of claim 35, wherein the providing chunk requests of the fragment request having the higher priority than the another fragment request is performed regardless of an order in which the fragment requests are received by the RM.

37. The method of claim 35, wherein the providing chunk requests of the fragment request having the higher priority than the another fragment request prior to remaining chunk requests of the another fragment request comprises:
usurping download of content of the another fragment request in favor of download of content of the higher priority fragment request without tearing down a connection used to download content of the another fragment request.

38. The method of claim 37, wherein the usurping download of content comprises the RM suspending requesting chunks for the another fragment request in favor of requesting chunks for the higher priority fragment request.

39. The method of claim 37, wherein the providing chunk requests of the fragment request having the higher priority than the another fragment request prior to remaining chunk requests of the another fragment request comprises:
cancelling a chunk request of the another fragment request, wherein the cancelled request is selected from the group consisting of the another fragment request and at least one chunk request of the fragment request.

40. The method of claim 39, further comprising:
re-issuing the cancelled request after the chunk requests of the higher priority fragment request are received.

41. The method of claim 35, further comprising:
resending, by the RM to the CM, at least a partial chunk request of the higher priority fragment request that has been sent but not completely received by the CM prior to sending chunk requests of a lower priority fragment request to facilitate a download completion time for the chunk requests of the higher priority fragment request which is earlier than download completion times of the chunk requests from the lower priority fragment request.

42. The method of claim 35, further comprising:
providing chunk requests of the another fragment request to the CM by the RM after exhausting the plurality of chunk requests of the higher priority fragment request.

43. The method of claim 34, wherein the providing chunk requests in accordance with the priority of the fragment requests comprises:
providing chunk requests having a higher priority than another fragment request to the CM by the RM prior to remaining chunk requests of the another fragment requested when higher priority fragment requests are currently available from the UA; and
prefetching lower priority fragments when the higher priority fragment requests are not currently available from the UA.

44. The method of claim 34, further comprising:
signaling, by the CM to the RM, that the CM is ready for an additional chunk request.

45. The method of claim 44, further comprising:
signaling, by the RM to the UA in response to the additional chunk request signaling by the CM, that the RM is ready for an additional fragment request, wherein the receiving fragment requests includes receiving a fragment request sent in response to the signaling that the RM is ready for an additional fragment request.

46. An apparatus for accelerating, by a transport accelerator (TA), delivery of content to a user agent (UA) of a client device, the apparatus comprising:
means for receiving, by a request manager (RM) of the TA from the UA, fragment requests for requesting chunks of the content, wherein priority information is provided by the UA in association with the fragment requests, wherein the priority information indicates a priority of a corresponding fragment request relative to other fragment requests;
means for subdividing, by the RM, the fragment requests each into a plurality of chunk requests; and
means for providing, by the RM to a connection manager (CM) of the TA, chunk requests of the plurality of chunk requests in accordance with a priority of the fragment requests from which the chunk requests were subdivided.

47. The apparatus of claim 46, wherein the means for providing chunk requests in accordance with the priority of the fragment requests comprises:
means for providing chunk requests of a fragment request having a higher priority than another fragment request to the CM by the RM prior to remaining chunk requests of the another fragment request.

48. The apparatus of claim 47, wherein the means for providing chunk requests of the fragment request having the higher priority than the another fragment request provides the chunk requests of the fragment request having the higher priority regardless of an order in which the fragment requests are received by the RM.

49. The apparatus of claim 47, wherein the means for providing chunk requests of the fragment request having the higher priority than the another fragment request prior to remaining chunk requests of the another fragment request comprises:
means for usurping download of content of the another fragment request in favor of download of content of the higher priority fragment request without tearing down a connection used to download content of the another fragment request.

50. The apparatus of claim 49, wherein the means for usurping download of content provides for the RM suspending requesting chunks for the another fragment request in favor of requesting chunks for the higher priority fragment request.

51. The apparatus of claim 49, wherein the means for providing chunk requests of the fragment request having the higher priority than the another fragment request prior to remaining chunk requests of the another fragment request comprises:
means for cancelling a chunk request of the another fragment request, wherein the cancelled request is selected from the group consisting of the another fragment request and at least one chunk request of the fragment request.

52. The apparatus of claim 51, further comprising:
means for re-issuing cancelled chunk requests after the chunk requests of the higher priority fragment request are received.

53. The apparatus of claim 47, further comprising:
means for resending, by the RM to the CM, at least a partial chunk request of the higher priority fragment request that has been sent but not completely received by the CM prior to sending chunk requests of a lower priority fragment request to facilitate a download completion time for the chunk requests of the higher priority fragment request which is earlier than download completion times of the chunk requests from the lower priority fragment request.

54. The apparatus of claim 47, further comprising:
means for providing chunk requests of the another fragment request to the CM by the RM after exhausting the plurality of chunk requests of the higher priority fragment request.

55. The apparatus of claim 47, wherein the means for providing chunk requests of the fragment request having the higher priority than the another fragment request prior to remaining chunk requests of the another fragment request is utilized to optimize bandwidth utilization by prefetching lower priority fragments when higher priority fragment requests are not currently available from the UA.

56. The apparatus of claim 46, further comprising:
means for signaling, by the CM to the RM, that the CM is ready for an additional chunk request.

57. The apparatus of claim 56, further comprising:
means for signaling, by the RM to the UA in response to additional chunk request signaling by the CM, that the RM is ready for an additional fragment request, wherein the receiving fragment requests includes receiving a fragment request sent in response to the signaling that the RM is ready for an additional fragment request.

58. A computer program product for accelerating, by a transport accelerator (TA), delivery of content to a user agent (UA) of a client device, the computer program product comprising:
a non-transitory computer-readable medium having program code recorded thereon, the program code including:
program code to receive, by a request manager (RM) of the TA from the UA, fragment requests for requesting chunks of the content, wherein priority information is provided by the UA in association with the fragment requests, wherein the priority information indicates a priority of a corresponding fragment request relative to other fragment requests;
program code to subdivide, by the RM, the fragment requests each into a plurality of chunk requests; and
program code to provide, by the RM to a connection manager (CM) of the TA, chunk requests of the plurality of chunk requests in accordance with a priority of the fragment requests from which the chunk requests were subdivided.

59. The computer program product of claim 58, wherein the program code to provide chunk requests in accordance with the priority of the fragment requests comprises:
program code to provide chunk requests of a fragment request having a higher priority than another fragment request to the CM by the RM prior to remaining chunk requests of the another fragment request.

60. The computer program product of claim 59, wherein the program code to provide chunk requests of the fragment request having the higher priority than the another fragment request prior to remaining chunk requests of the another fragment request comprises:
program code to usurp download of content of the another fragment request in favor of download of content of the higher priority fragment request without tearing down a connection used to download content of the another fragment request, wherein the usurping download of content comprises the RM suspending requesting chunks for the another fragment request in favor of requesting chunks for the higher priority fragment request.

61. The computer program product of claim 60, wherein the program code to provide chunk requests of the fragment request having the higher priority than the another fragment request prior to remaining chunk requests of the another fragment request comprises:
program code to cancel a chunk request of the another fragment request, wherein the cancelled request is selected from the group consisting of the another fragment request and at least one chunk request of the fragment request.

62. An apparatus for accelerating, by a transport accelerator (TA), delivery of content to a user agent (UA) of a client device, the apparatus comprising:
at least one processor; and
a memory coupled to the at least one processor,
wherein the at least one processor is configured:
to receive, by a request manager (RM) of the TA from the UA, fragment requests for requesting chunks of the content, wherein priority information is provided by the UA in association with the fragment requests, wherein the priority information indicates a priority of a corresponding fragment request relative to other fragment requests;
to subdivide, by the RM, the fragment requests each into a plurality of chunk requests; and
to provide, by the RM to a connection manager (CM) of the TA, chunk requests of the plurality of chunk requests in accordance with a priority of the fragment requests from which the chunk requests were subdivided.

63. The apparatus of claim 62, wherein the at least one processor is further configured:
to provide the chunk requests of the fragment request having a higher priority than another fragment request to the CM by the RM prior to remaining chunk requests of the another fragment request.

64. The apparatus of claim 63, wherein the at least one processor is further configured:
to usurp download of content of the another fragment request in favor of download of content of the higher priority fragment request without tearing down a connection used to download content of the another fragment request, wherein the usurping download of content comprises the RM suspending requesting chunks for the another fragment request in favor of requesting chunks for the higher priority fragment request.

65. The apparatus of claim 64, wherein the at least one processor is further configured:
to cancel a chunk request of the another fragment request, wherein the cancelled request is selected from the group consisting of the another fragment request and at least one chunk request of the fragment request.
